(19) United States
(12) Patent Application Publication
(10) Pub. No.: US 2023/0185003 A1
(43) Pub. Date: Jun. 15, 2023

(54) SUBSTRATES THAT EXHIBIT INTERFERENCE PATTERNS UPON THE REFLECTION OF INCIDENT ELECTROMAGNETIC RADIATION AND METHODS OF MAKING AND USING THEREOF

(71) Applicant: THE PENN STATE RESEARCH FOUNDATION, (US)

(72) Inventors: Lauren Dell ZARZAR, University Park, PA (US); Amy GOODLING, University Park, PA (US); Caleb Meredith, Boalsburg, PA (US)

(21) Appl. No.: 17/926,399

(22) PCT Filed: May 19, 2021
(86) PCT No.: PCT/US21/33171

§ 371 Date: Nov. 18, 2022

(51) Int. Cl. G02B 5/13; B29D 11/00

(52) U.S. Cl. CPC G02B 5/13; B29D 11/0074; B42D 25/378

(57) ABSTRACT

Disclosed are methods of forming substrates which exhibit an interference pattern (e.g., structural color) upon reflection of incident electromagnetic radiation. Provided herein are methods for creating iridescent structural color with large angular spectral separation. The effect can be generated at interfaces with dimensions that are orders of magnitude larger than the wavelength of visible light. The structural color results from light interacting with the geometrical structure of an interface (e.g., a hemispheric/dome-shaped interface between two materials having different refractive indices) in a way that causes light interference. The structural color observed when viewing the surface depends upon the angle of the viewer as well as the angle of the light incident to the surface.

### CROSS-REFERENCE TO RELATED APPLICATIONS

This application claims benefit of U.S. Provisional Application No. 63/027,121, filed May 19, 2020, which is hereby incorporated herein by reference in its entirety.

### STATEMENT REGARDING FEDERALLY SPONSORED RESEARCH OR DEVELOPMENT

This invention was made with government support under Grant No. CBET1804092 awarded by the National Science Foundation. The Government has certain rights in the invention.

### BACKGROUND

Coloration significantly influences how persons perceive and interact with the world. Structural colors created by interference of light are of special interest because they do not fade (unlike dyes and pigments) and exhibit iridescence, meaning the colors shift position or hue with illumination or viewing angle. Beyond aesthetic applications of color in self-expression, such as for cosmetics and apparel, structural color and tailored spectral reflectance of coatings are useful for technological, safety/security, and military applications with broad societal impact. Examples include color-shifting holograms on security labels and anti-counterfeiting measures, camouflaging coatings, retroreflective signs and road markings, and laser-guided navigation.

In spite of their tremendous potential, current strategies to enable structural coloration have not yet been widely adopted in industrial and commercial application due to a number of challenges. Structural colors due to optical interference are most often generated by either diffraction or thin film interference mechanisms. Such effects require nanoscale periodicity on scale of the wavelength of visible light (˜300-800 nm) and typically contain interfaces of high-refractive-index-contrast metals and oxides. As such, they are expensive to process (e.g., require vacuum deposition of inorganic films) and may have limited optical customizability (e.g. hue/shade/tint, angular positions and separation of colors, interference pattern) due to restrictions in geometry imposed by nano-manufacturing challenges. Accordingly, improved compositions, methods, and articles are needed.

### SUMMARY

Provided herein are methods for creating iridescent structural color with large angular spectral separation. The effect can be generated at interfaces with dimensions that are orders of magnitude larger than the wavelength of visible light. The structural color results from light interacting with the geometrical structure of an interface (e.g., a hemispheric/dome-shaped interface between two materials having different refractive indices) in a way that causes light interference. The structural color observed when viewing the surface depends upon the angle of the viewer as well as the angle of the light incident to the surface. Specifically, the geometry of the interface and the sharp difference in refractive index—a measure of how fast light passes through an object—allows for total internal reflection. This occurs when light hits a boundary between substances with different refractive indexes at a specific angle such that a significant percentage of the incident light is reflected, rather than losing some of the light to refraction. Once light enters the geometrical structure, the light wave can bounce two or more times. Light bouncing by different numbers of times and along different paths interfere to generate color.

Described herein are a variety of architectures, including two-dimensional and three-dimensional patterned polymer surfaces, that exploit the principles described above to create patterns of iridescent colors. Importantly, this structural coloration is controllable and can be readily generated at microscale interfaces using the methods described herein. The principles and methods described herein can be used to generate materials with applications in optics, functional colloidal inks (including for security and anti-counterfeiting) and paints including adaptive camouflage, brilliantly-colored cosmetics, displays, and sensors.

### DESCRIPTION OF DRAWINGS

FIGS. 1A-1F depict the fabrication of microwells and domes with structural coloration due to interference from TIR. FIG. 1A is a schematic of a concave geometry that would be expected to generate interference from multiple total internal reflections of incident light. Collimated light impinges upon a concave interface between a high and a low index medium and undergoes TIR. Different paths of TIR have different lengths leading to a shift in phase that causes interference and structure color. FIG. 1B depicts a method of fabrication for monodisperse microwells and domes. (i) A thin layer of uncured NOA 71 monomer is pipetted into a Petri dish. On top, an aqueous surfactant solution containing monodisperse glass particles is added. The glass particles assemble at the water-NOA 71 interface. (ii) The sample is cured with UV light, leaving the particles embedded partially in the NOA 71. (iii-iv) The surface is molded in crosslinked PDMS to form wells. (v) Polymer domes replicated from the PDMS wells. FIG. 1C and FIG. 1D depict scanning electron microscopy (SEM) and optical profilometry images, respectively, of PDMS wells formed from soda lime glass particles (95% of particles having diameters in the range of 40-43 μm) embedded in NOA 71 deposited from an aqueous solution of 1 mM CTAB and 20 v/v % isopropyl alcohol. The resultant wells have r=20.7±1.4 θ_{CA}=76.0±5.7° (average and standard deviation as measured by the optical profilometry, sample size is 45 for radius and 15 for contact angle calculations, respectively.) Scale, 25 μm. FIG. 1E depicts a reflection optical micrograph of OG 142-87 domes (n=1.51) replicated from PDMS wells with same geometry as in (c-d) submerged in heptane (n=1.38). Scale, 25 μm. FIG. 1F are photographs of the same sample as seen in (e) of epoxy OG 142-87 domes (n=1.51) submerged in heptane (n=1.38), viewed macroscopically under collimated white light illumination. As the viewing angle rotates, the color changes. Scale, 1 cm.

FIG. 2 is a schematic of the method used to characterize the iridescent color distribution in spherical coordinates. Collimated white LED light illuminates the sample through a 3 mm hole in a translucent hemisphere (a half ping-pong ball). The reflected colors are projected onto the inside surface of the translucent hemisphere, which acts as a screen. The angles of θ and φ are defined such that θ=0° corresponds to the sample normal and the light source is at φ=0°.

FIGS. 3A and 3B depicts how the radius of curvature and contact angle of the microwells and domes affects the structural color. FIG. 3A depicts how the contact angle of the microdomes was tuned by using varying concentrations of isopropyl alcohol during initial assembly of particles which affects structural color. The top panel depicts resultant geometries of structures replicated from PDMS molds of 40-43 μm diameter particles embedded in NOA 71 from (i) 0 v/v %, (ii) 10 v/v %, and (iii) 20 v/v % isopropyl alcohol with 1 mM CTAB. These conditions yielded r=20.7±1.4 μm and θ_{CA}=93±5.1°, 82±5.4° and 76.0±5.7° for geometries (i-iii), respectively. The radius of curvature and contact angles were measured using optical profilometry (second row, scale 20 μm). The third panel contains photographs of the color distribution generated from replica epoxy domes (n=1.51) submerged in water (n=1.33) for geometries (i-iii). Light angle (θ=45°, φ=0°), camera angle (θ=0°, φ=0°). Scale, 1 cm. The bottom panel shows calculated color distributions. Input parameters for model values: r=19.5 μm and θ_{CA}=95.0°, 80.0° and 76.0°. FIG. 3B depicts how varying the diameter of monodisperse glass particles used during fabrication was used to tune the radius of curvature of the resultant microwells and domes. Specifically, the samples shown were epoxy dome replicas fabricated from PDMS molds of particles of (i) 29-32 μm, (ii) 40-43 μm and (iii) 98-102 μm diameter deposited from aqueous surfactant solution of 1 mM CTAB and 20 v/v % isopropyl alcohol. These conditions yielded geometries of (r=14.1±1.2 μm, θ_{CA}=79.2±) 3.9° for (i), (r=20.7±1.4 μm, θ_{CA}=76.1±5.7°) for (ii), and (r=52.1±3.2 μm, θ_{CA}=86.4±4.6°) for (iii). Stated dimensions are the averages and standard deviations as measured by optical profilometry (second row, scale 20 μm). The third and fourth panels are photographs of the color distributions and calculated color distributions, respectively, correlating to the dimensions of (b,i-iii) (scale, 1 cm). Input parameters for the calculated color distributions: (r=14.0 μm, θ_{CA}=79.0°) for (i), (r=19.5 μm, θ_{CA}=76.0°) for (ii), and (r=50.0 μm, θ_{CA}=85.0°) for (iii).

FIGS. 4A-4D depict how mechanical deformation was used to create ellipsoidal wells and domes and alter structural color. FIG. 4A depicts Transmission optical micrographs of wells that have been stretched in two different directions, which correspond to the macroscale images in FIG. 4B. Scale, 50 μm. FIG. 4B shows photographs of elastomeric PDMS wells (n=1.42) with the same geometry as FIG. 4A, (r=20.7±1.4 μm, θ_{CA}=76.0±5.7°, n=1.51) filled with a high index UV-curable elastomer (Dowsil VE-6001, (n=1.53) being stretched and viewed under two different illumination and viewing conditions. Top row illumination angle (θ=0°, φ=0°) and camera angle (θ=15°, φ=90°), and bottom row illumination angle (θ=50°, φ=0°) and camera angle (θ=50°, φ=110°). The three images in each row correspond to the unstretched sample (middle) and stretching in two orthogonal directions (left and right images). Yellow arrows show the direction of stretching. Scale, 1 cm. FIGS. 4C and 4C show photographs of the projected color distributions from ellipsoidal domes with geometry similar to FIGS. 4A and 4B but replicated in the epoxy OG 142-87 (n=1.51) and submerged in water (n=1.33). Schematics in the top row illustrate the surface orientation of the ellipsoidal domes. Images in FIG. 4C were taken under illumination at (θ=0°, φ=0°) and images in FIG. 4D were taken under illumination at (θ=50°, φ=0°). In FIG. 4D, the major axis of the ellipsoids is at φ=90° (leftmost image) and φ=0° (rightmost image) defined relative to the light, as shown in the top-row schematics. Scale, 1 cm.

FIGS. 5A to 5D depict patterned and responsive structural color patterns achieved by varying refractive index contrast. In FIG. 5A, PDMS wells (r=14.1±1.2 μm, θ_{CA}=79.2±) 3.9° were filled with oils of increasingly higher refractive index to probe the effect of refractive index contrast on the structural color. Different oil refractive indices were achieved through mixing of tetrabromoethane (n=1.64), benzyl benzoate (n=1.57) and/or n-decane (n=1.42). As the refractive index contrast was reduced, the color began to fade as less light undergoes TIR along the interface. Scale, 1 cm. In FIG. 5B, PDMS wells from FIG. 5A were filled with different refractive index oils (benzyl benzoate, n=1.57, and tetrabromoethane, n=1.64), to create a structurally-colored image of a rose. Camera angle: (θ=50°, φ=40°), illumination angle: (θ=50°, φ=0°). Scale, 1 cm. In FIG. 5C, temperature responsive color change achieved by filling PDMS wells (same geometry as used in (a) with 5CB liquid crystal. At room temperature, the nematic 5CB anchored on the surface of the PDMS and the birefringence affected interference from TIR resulting in less colorful, pinkish hues. As the sample was heated, the 5CB underwent a nematic to isotropic transition, losing molecular alignment, and coloration from TIR interference became more intense. Scale, 5 mm. FIG. 5D depicts iridescent color switched on and off in response to temperature by varying the index contrast at the optical interface through oil mixing. Domes of epoxy OG 142-87 (n=1.51) with same geometry as in FIG. 5A were immersed in low index 2-(trifluoromethyl)-3-ethoxydodecafluorohexane (oil 2, n=1.33) onto which an immiscible layer of higher index hydrocarbon (5:1 volume ratio of toluene to benzyl benzoate, oil 1, n=1.50) was added. A 3:1 volume ratio of hydrocarbon to fluorocarbon oil was used. The sample and solution were heated above the oils' critical solution temperature (T_{C}<T=° C.), which led to oil mixing (new refractive index n=1.44). This index contrast with the polymer domes was thus reduced and the color faded. Scale, 5 mm.

FIG. 6 depicts how varying microdome radius of curvature and contact angle and effects on structural color under varying refractive index contrast conditions. Photographs of epoxy OG 142-87 dome arrays (n=1.49) that were submerged in three different solvents: perfluorooctane (n=1.28), water (n=1.33) and heptane (n=1.387) for 9 geometries of domes, varying in radius of curvature and contact angle, as stated in the figure. For all images, the illumination angle was (θ=40°, φ=0°), and the camera angle was (θ=0°, φ=0°) according to the spherical coordinate system diagrammed in FIG. 2. All photographs were taken under the same camera settings, including exposure, so as to compare relative intensities of reflection and color saturation. Scale, 1 cm. Generally, the larger radius of curvature structures (e.g. r=52.1±3.2 μm) produce more vibrant colors at lower index contrasts, while smaller radius of curvature structures (e.g. r=14.1±1.2 μm) reflect more intense colors at higher index contrast. This is an indirect expression of the condition that for the most intense colors to be observed, the optical path length difference of interfering ray trajectories has to be on the order of the wavelength of the light. For example, of the three sizes of microdome surfaces tested (r=14, 21, 52 μm, n=1.49) the largest domes only exhibited vibrant coloration when submerged in the highest index oil (heptane, n=1.38). For all the different sizes of domes, reducing the index contrast by raising the index of the oil led to larger color separation.

FIG. 7 is a schematic of polymer refractive indices and geometry of an examplemicrowell surface. An array of these microwells is viewed macroscopically outside in sunlight at different angles to see different colors.

FIG. 8 shows the comparison of μ-TIR coatings with competitor coatings. Shown are different length scales and the color distribution map of various coating. All products (other than μ-TIR) are based on either diffraction gratings (as seen clearly in the microscopic images of SpectraFlair and the security label) and/or thin film interference (occurring between nanoscale metallic and transparent layers within flakes in Gloss Flip and SpectraFlair). Depending on the optical mechanism for light interference, different distributions of reflected color are observed by projection onto the translucent dome. The widest angular separation of colors is from the μ-TIR mechanism.

FIG. 9 shows a method of manufacture and analysis of the compositions described herein comprising the creation of molds and masters of microstructures to be used for hot embossing, which enables scalable fabrication of μ-TIR surfaces which are optically characterized for iterative design of custom microstructures.

FIGS. 10A and 10B depict multiphoton lithography fabrication of polygonal microstructured μ-TIR surfaces. FIG. 10A is a schematic of a multiphoton fabrication method in which a focused laser is used to additively manufacture 3D microstructures. FIG. 10B shows results of color distributions from arrays of regular polygons with number of sides ranging from 2 to 6. Scanning electron micrographs (SEM) are shown for a structure for each sample (scale, 10 μm), with angular color distribution at the bottom. Polygonal structures enable far more diverse reflection spectra compared to spherical surfaces.

FIG. 11 depicts the electroformation process for converting microstructure masters into nickel molds. The electrochemical setup is comprised of a cathode (polymer master sputtered with platinum), a nickel anode, and buffered aqueous electrolyte solution. The rate of nickel deposition is proportional to the current density which is based on the applied voltage and electrolyte concentration.

FIGS. 12A and 12B depicts two approaches for μ-TIR coating production using embossing. In FIG. 12A showing an approach to fabricate μ-TIR coatings in a single step, a bilayer of thermoplastic polymer films already containing the high-to-low refractive index interface is hot embossed into a microstructure array. In FIG. 12B showing an alternative two-step approach, a single low (or high) index polymer film is hot embossed, then tape casting/photopolymerization is used to deposit the second polymer with the high (or low) index interface to generate μ-TIR.

FIGS. 13A-13C show examples of images and patterns of structural color by μ-TIR. FIG. 13A shows a structurally colored image of a penguin made in biphasic oil droplets where the geometry is controlled using a photo-responsive surfactant. FIG. 13B shows how different high index oils painted onto low index wells used are used to create a structural color image of a rose from different refractive index contrasts. FIG. 13C shows the same high index oils are painted onto low index wells as in FIG. 13B, instead constructed in a grid pattern that reveals a design at certain viewing angles. By designing microstructures of different geometries, we aim to create similar images and patterns in all-solid μ-TIR films.

FIG. 14 is a schematic illustration of an example TIR microstructure.

FIG. 15 illustrates example example TIR microstructures that comprises truncated arcuate interfaces.

FIG. 16 illustrates a substrate that comprises a three-dimensional array of TIR microstructures.

FIG. 17 illustrates an example method of fabricating an interface master.

FIG. 18 illustrates embossing methods that can be used to form the substrates described herein.

FIG. 19 illustrates methods of forming microreplicated surfaces and/or substrates using embossing processes.

FIG. 20 illustrates methods of disposing second materials on microreplicated surfaces (e.g., the embossed single layer substrates formed as shown in FIG. 19) to form substrates.

FIG. 21 illustrates an example substrate formed using particles embedded in a base material.

FIG. 22 illustrates example particlates and flakes formed from substrates described herein, as well as coatings and coating compositions formed from these particulates and flakes.

FIGS. 23A-23E illustrate an example method for fabricating an interface master.

FIG. 24 illustrates a method of forming patterned substrates by varying the geometry of TIR microstructures and/or the optical properties of component materials across a surface of the substrate.

FIG. 25 illustrates a method of forming patterned substrates by varying the geometry of TIR microstructures (e.g., the size of particles embedded in the base material) and/or the optical properties of component materials across a surface of the substrate.

FIG. 26 illustrates an example substrate containing a three-dimensional array of TIR microstructures in which three different index materials are used.

FIG. 27 illustrates a method of making the three-dimensional array of TIR microstructures shown in FIG. 26.

FIG. 28 illustrates the inclusion of a pigment in the first material (low index material) used to form a TIR microstructure.

FIG. 29 illustrates a method of forming an array of TIR microstructures using a screen printing process. In Step 1, a patterned screen is places on a base substrate. In Step 2, a curable resin is applied across the mesh screen. In Step 3, the screen is removed to form curved dome microstructures. In Step 4, the resin is cured, and the omes are coated with a second material (e.g., a low index layer) to form an array of TIR microstructures.

FIG. 30 illustrates a method of forming an array of TIR microstructures on a non-planar surface using a thermoforming process.

FIG. 31 illustrates a method of forming an array of TIR microstructures on a non-planar surface using an injection molding process.

FIG. 32 illustrates a method of laser patterning an array of TIR microstructures formed from a thermoplastic polymer.

### DETAILED DESCRIPTION

### Definitions

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

The terms “iridescent” and “iridescence” as used herein are each given its ordinary meaning in the art and generally refer to color that changes as a function of light incidence and/or viewing angle.

As used herein, a “fluid” is given its ordinary meaning, i.e., a liquid or a gas. A fluid cannot maintain a defined shape and will flow during an observable time frame to fill the container in which it is put. Thus, the fluid may have any suitable viscosity that permits flow. If two or more fluids are present, each fluid may be independently selected among essentially any fluids (liquids, gases, and the like) by those of ordinary skill in the art.

Described herein are methods for the generation of tunable electromagnetic radiation such as coloration (e.g., iridescence, structural color) and/or interference patterns from, for example, two-dimensional and three-dimensional microstructured surfaces (e.g., comprising a plurality of microdomes and/or microwells). In some embodiments, the surfaces can produce visible color (e.g., structural color) without the need for dyes. Such colors may be generated in articles wherein the morphology of the surfaces can be controlled dynamically, or the refractive index contrast at the interfaces where TIR occurs can be controlled dynamically, which may permit the tunability of the perceived spectrum throughout the visible, infrared, UV, microwave, regions, etc. (e.g., containing wavelengths of 1 nanometer to 1 centimeter). In some embodiments, the surface morphology may be fixed such that the surface obtains a permanent color (or array of colors) or interference pattern. In some cases, substrates derived thereof may be used to generate structural coloration using curved and/or polygonal material interfaces e.g., that create spectral separation by interference effects occurring due to, for example, cascaded internal reflection of light at the interface. In some embodiments, the surfaces described herein comprise an interface (e.g., an interface between two or more materials where total internal reflection can occur) and a geometry in which multiple total internal reflection can occur. Without wishing to be bound by theory, electromagnetic radiation travelling along different trajectories of total internal reflection at an interface may, in some cases, interfere, generating color, and/or generating interference effects such as interference patterns. In some embodiments, a first portion of the electromagnetic radiation may undergo total internal reflection and a second portion of the electromagnetic radiation is reflected (e.g., by a mechanism different that total internal reflection). In some embodiments, substantially all electromagnetic radiation incident to the interface undergoes total internal reflection.

In certain embodiments, the structural color may be tuned by changing the curvature or angles of sides, the radius of curvature (e.g., of the interface), and/or the refractive index of one or more materials at the interface. Non-limiting examples of suitable interfaces for generating tunable coloration include solid-solid interfaces (e.g. abutting layers of solid materials), solid-gas interfaces (e.g. a microstructured surface in air), and solid-liquid interfaces (e.g. a microstructured surface submerged in liquid such as water).

Unlike the precise nanoscale periodicity generally required to create structural color from diffraction gratings, photonic crystals, or multilayers, the optical interference created by multiple total internal reflection as described herein may, in some embodiments, advantageously be generated at concave interfaces with dimensions on the microns scale (e.g., having a characteristic dimension of greater than or equal to 1 micron and less than or equal to 1000 microns, greater than or equal to 1 micron and less than or equal to 250 microns, greater than or equal to 10 microns and less than or equal to 250 microns).

Without wishing to be bound by theory, generation of tunable coloration, patterns of coloration, or interference patterns may be due to interference phenomena occurring when light undergoes multiple total internal reflections at curved, microscale, nanoscale, or macroscale interfaces (e.g., at an interface between two or more abutting or adjacent materials). Such tunable coloration or interference patterns may be implemented in a variety of materials and systems including 2D and 3D patterned surfaces without the need for precise control of nanoscale periodicity. As such, the substrates described herein may be useful in a wide range of applications including inks, paints, cosmetics, personal care products, displays, sensors (e.g., colorimetric sensors for chemical and/or physical parameters such as heat, presence of an analyte (e.g., chemical, biological component), pressure, mechanical deformation, humidity, etc.), binders, displays and signage, point-of-care medical diagnostics, coatings, as well as for fundamental exploration in fields ranging from optics and photonics to complex fluids and colloids.

The substrates, articles, and methods as described herein offer numerous advantages to systems known in the art, for producing color or optical interference. For example, the substrates described herein may, in some cases, produce structural color (e.g., more brilliant and longer lasting compared to dyes), produce tunable color (e.g., such that small changes in the shape of the interface can be used to alter the color which is useful for, for example, sensors and displays), do not require nanoscale particles and/or chemical fluorophores and/or pigments, provide a colorimetic readout (e.g., for responsive sensors), generate color in reflection, generate an optical interference pattern, and/or use only environmental light as the light source.

In some embodiments, the color generated by the substrate is due, at least in part, to total internal reflection of electromagnetic radiation. For example, light entering the substrate may be refracted at an interface between a first material and a second material, immiscible with the first material. In some embodiments, such refraction causes an initial color separation (e.g., due to optical dispersion). In certain embodiments, during and/or after refraction, light propagates between the first material and the second material via total internal reflection.

Substrates

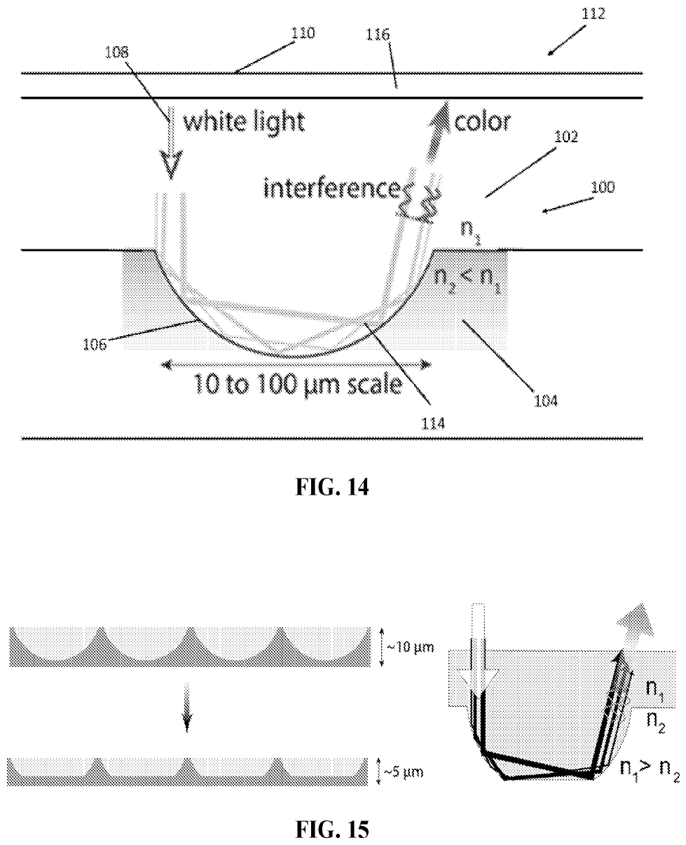

Provided herein are substrates that exhibit an interference pattern upon reflection of incident electromagnetic radiation. These substrates can comprise a plurality of TIR microstructures. Referring now to FIG. 14, each of the TIR microstructures (100) can comprise a first material (102), a second material (104) abutting the first material, and an interface (106) between the first material and the second material. As used herein, when a material is referred to as “abutting” or being “adjacent” to another material, it can be directly abutting or adjacent to the other material, or one or more intervening layers (e.g., layers including, but not limited to, a third material, a polymer layer, a glass layer, a coating, and/or a fluid) also may be present. A material that is “directly abutting” it “directly adjacent” another component means that no intervening layer is present. In certain embodiments described herein, each of the TIR microstructures (100) can comprise a first material (102), a second material (104) directly abutting the first material, and an interface (106) between the first material and the second material.

Referring again to FIG. 14, the interface (106) is configured such that at least a portion of electromagnetic radiation (108) incident a surface (110) of the substrate (112) at at least one illumination angle undergoes multiple total internal reflections (114) between the first material (102) and the second material (104) (e.g., resulting in spectral color generation or interference). For example, the electromagnetic radiation incident a surface of the substrate at at least one illumination angle can undergo at least two total internal reflections, at least three total internal reflections, at least four total internal reflections, at least five total internal reflections, at least ten total internal reflections, or many more total internal reflections. The number of total internal reflections can vary based on the geometry of the interface, the identity of the first material and the second material, and the illumination angle of the incident light.

In some embodiments, the first component comprises a first material (e.g., a liquid such as a fluorocarbon or a hydrocarbon, a solid such as a polymer, a gas) and the second component comprises a second material, different than the first material in type, opacity, reflective index, phase, and/or structure.

In some embodiments, the first material and the second material may be immiscible. Immiscible, as used herein, refers to two materials (or a material and a material) having an interfacial tension of greater than or equal to 0.01 mN/m as determined by a spinning drop tensiometer. By contrast, miscible refers to two materials (or a material and a material) having an interfacial tension of less than 0.01 mN/m as determined by a spinning drop tensiometer.

Referring again to FIG. 14, in some embodiments, an optional outer component 116 is present. While FIG. 14 illustrates an interface formed between two abutting solid materials, those of ordinary skill in the art would understand based upon the teachings of this specification that total internal reflection may occur at a variety of interfaces formed between two materials (e.g., two solids, a solid and a liquid, or a solid and a gas). In certain embodiments, the first component has a first refractive index greater than a second refractive index of the second component, as described in more detail below.

As shown in FIG. 14, in some embodiments, the first material and/or the second material are structured such that an arcuate (curved) interface is present between the first material and the second material. In some embodiments, the interface (106) is concave relative to incident electromagnetic radiation (108). For example, in some embodiments, each of the TIR microstructures can comprise a well (e.g., microwell) present at the interface between the first material and the second material. While this example microstructure is entirely concave relative to incident electromagentic radiation, one of ordinary skill in the art would understand that the suitable microstructures can include convex regions, provided that at least a portion of the microstructure is concave so as to provide for the desired reflection of incident light towards a viewer. In some embodiments, option third material (116) can be present and adjacent first material. In some such embodiments, the refractive index of the first material and the refractive index of the second material can be selected such that at least a portion of electromagnetic radiation incident to the interface between the first material and the second material undergoes total internal reflection at the interface.

While much of the description herein describes the interface between arcuate (curved) surfaces, those of ordinary skill in the art would understand, based upon the teachings of this specification, that the term ‘curved’ shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

In other embodiments, the interface may comprise a plurality of flat surfaces (e.g., a polygonal interface). For example, in some embodiments, the curved surface comprises a plurality of sides. In some embodiments, the curved surface comprises two sides, three sides, four sides, five sides, six sides, seven sides, eight sides, nine sides, ten sides, or more. In some embodiments, at least a portion of the interface may be substantially flat. In certain embodiments, the the interface comprises a truncated arcuate interface, as shown in FIG. 15. Truncated arcuate interfaces can include a flattened bottom and curved vertical segments. The incorporation of a truncated arcuate interfaces can reduce the thickness of substrates containing the TIR microstructures.

The term material, as used herein, generally refers to a portion of a substrate comprising a group of substantially similar molecules, a group of substantially similar compounds, and/or a phase of matter (e.g., a non-aqueous phase, an aqueous phase) comprising such molecules and/or compounds. Those skilled in the art would understand that the term material is not intended to refer to a single molecule or atom. In some embodiments, a material is a liquid phase (e.g., a gas phase, an aqueous phase, non-aqueous phase) comprising a group of substantially similar compounds and/or molecules. In some embodiments, a material is a solid phase (e.g., a polymer, glass). In some embodiments, a material is a gel. For example, in some cases, each material may occupy at least about 1 vol %, at least about 2 vol %, at least about 5 vol %, at least about 10 vol %, at least about 20 vol %, at least about 50 vol %, at least about 70 vol %, at least about 90 vol %, at least about 95 vol %, or at least about 99 vol % of the total volume of the two or more materials.

In some embodiments, the first material is present in each substrate in an amount greater than or equal to 10 vol %, greater than or equal to 15 vol %, greater than or equal to 20 vol %, greater than or equal to 25 vol %, greater than or equal to 30 vol %, greater than or equal to 35 vol %, greater than or equal to 40 vol %, greater than or equal to 45 vol %, greater than or equal to 50 vol %, greater than or equal to 55 vol %, greater than or equal to 60 vol %, greater than or equal to 65 vol %, greater than or equal to 70 vol %, greater than or equal to 75 vol %, greater than or equal to 80 vol %, or greater than or equal to 85 vol % on average versus the total volume of all materials within each substrate.

In certain embodiments, the first material is present in each substrate in an amount less than or equal to 90 vol %, less than or equal to 85 vol %, less than or equal to 80 vol %, less than or equal to 75 vol %, less than or equal to 70 vol %, less than or equal to 65 vol %, less than or equal to 60 vol %, less than or equal to 55 vol %, less than or equal to 50 vol %, less than or equal to 45 vol %, less than or equal to 40 vol %, less than or equal to 35 vol %, less than or equal to 30 vol %, less than or equal to 25 vol %, less than or equal to 20 vol %, or less than or equal to 15 vol % on average versus the total volume of all materials within each substrate.

Combinations of the above-referenced ranges are also possible (e.g., greater than or equal to 10 vol % and less than or equal to 90 vol %, greater than or equal to 35 vol % and less than or equal to 65 vol %, greater than or equal to 45 vol % and less than or equal to 55 vol %). Other ranges are also possible.

In certain embodiments, the second material is present in each substrate in an amount greater than or equal to 10 vol %, greater than or equal to 15 vol %, greater than or equal to 20 vol %, greater than or equal to 25 vol %, greater than or equal to 30 vol %, greater than or equal to 35 vol %, greater than or equal to 40 vol %, greater than or equal to 45 vol %, greater than or equal to 50 vol %, greater than or equal to 55 vol %, greater than or equal to 60 vol %, greater than or equal to 65 vol %, greater than or equal to 70 vol %, greater than or equal to 75 vol %, greater than or equal to 80 vol %, or greater than or equal to 85 vol % on average versus the total volume of all materials within the substrate.

In some embodiments, the second material is present in each substrate in an amount less than or equal to 90 vol %, less than or equal to 85 vol %, less than or equal to 80 vol %, less than or equal to 75 vol %, less than or equal to 70 vol %, less than or equal to 65 vol %, less than or equal to 60 vol %, less than or equal to 55 vol %, less than or equal to 50 vol %, less than or equal to 45 vol %, less than or equal to 40 vol %, less than or equal to 35 vol %, less than or equal to 30 vol %, less than or equal to 25 vol %, less than or equal to 20 vol %, or less than or equal to 15 vol % on average versus the total volume of all materials within each substrate.

Combinations of the above-referenced ranges are also possible (e.g., greater than or equal to 10 vol % and less than or equal to 90 vol %, greater than or equal to 35 vol % and less than or equal to 65 vol %, greater than or equal to 45 vol % and less than or equal to 55 vol %). Other ranges are also possible.

In certain embodiments, the substrate comprises two or more materials, each having a particular refractive index. For example, in some embodiments, the refractive index of the first material may be different (e.g., greater than) than the refractive index of the second material. Suitable materials for the materials of the articles are described in more detail below. Those of ordinary skill in the art would be capable of selecting materials with suitable refractive indices based upon the teachings of this specification.

In some embodiments, the refractive index (measured at 20° C. at the wavelength of electromagnetic radiation undergoing total internal reflection) of the first material may be greater than or equal to 1, greater than or equal to 1.1, greater than or equal to 1.2, greater than or equal to 1.25, greater than or equal to 1.3, greater than or equal to 1.35, greater than or equal to 1.4, greater than or equal to 1.45, greater than or equal to 1.5, greater than or equal to 1.55, greater than or equal to 1.6, greater than or equal to 1.7, greater than or equal to 1.8, greater than or equal to 1.9, greater than or equal to 2, greater than or equal to 2.1, greater than or equal to 2.2, greater than or equal to 2.3, greater than or equal to 2.4. In certain embodiments, the refractive index of the first material may be less than or equal to 2.5, less than or equal to 2.4, less than or equal to 2.3, less than or equal to 2.2, less than or equal to 2.1, less than or equal to 2, less than or equal to 1.9, less than or equal to 1.8, less than or equal to 1.7, less than or equal to 1.6, less than or equal to 1.55, less than or equal to 1.5, less than or equal to 1.45, less than or equal to 1.4, less than or equal to 1.35, less than or equal to 1.3, less than or equal to 1.25, less than or equal to 1.2, or less than or equal to 1.1. Combinations of the above referenced ranges are also possible (e.g., greater than or equal to 1 and less than or equal to 1.6, greater than or equal to 1.2 and less than or equal to 1.6, greater than or equal to 1.25 and less than or equal to 1.4, greater than or equal to 1.2 and less than or equal to 1.3). Other ranges are also possible.

In some embodiments, the refractive index (measured at 20° C. at the wavelength of electromagnetic radiation undergoing total internal reflection) of the second material may be greater than or equal to 1.0, greater than or equal to 1.1, 1.2, greater than or equal to 1.25, greater than or equal to 1.3, greater than or equal to 1.35, greater than or equal to 1.4, greater than or equal to 1.45, greater than or equal to 1.5, or greater than or equal to 1.55, greater than or equal to 1.6, greater than or equal to 1.7, greater than or equal to 1.8, greater than or equal to 1.9, greater than or equal to 2, greater than or equal to 2.1, greater than or equal to 2.2, greater than or equal to 2.3, greater than or equal to 2.4. In certain embodiments, the refractive index of the first material may be less than or equal to 2.5, less than or equal to 2.4, less than or equal to 2.3, less than or equal to 2.2, less than or equal to 2.1, less than or equal to 2, less than or equal to 1.9, less than or equal to 1.8, less than or equal to 1.7, less than or equal to 1.6, less than or equal to 1.55, less than or equal to 1.5, less than or equal to 1.45, less than or equal to 1.4, less than or equal to 1.35, less than or equal to 1.3, less than or equal to 1.25, less than or equal to 1.2, or less than or equal to 1.1. Combinations of the above referenced ranges are also possible (e.g., greater than or equal to 1 and less than or equal to 1.6, greater than or equal to 1.2 and less than or equal to 1.6, greater than or equal to 1.25 and less than or equal to 1.4, greater than or equal to 1.3 and less than or equal to 1.4). Other ranges are also possible. Those of ordinary skill in the art would be capable of selecting suitable methods for determining the refractive index of a material, based upon the teachings of this specification, and as described above.

In certain embodiments, a magnitude of a difference in refractive index between the refractive index of the first material and the refractive index of the second material may be greater than or equal to 0.01, greater than or equal to 0.05, greater than or equal to 0.1, greater than or equal to 0.15, greater than or equal to 0.2, greater than or equal to 0.25, greater than or equal to 0.5, or greater than or equal to 1.0. In some embodiments, the magnitude of the difference in refractive index between the refractive index of the first material and the refractive index of the second material may be less than or equal to 1.5, less than or equal to 1.0, less than or equal to 0.5, less than or equal to 0.25, less than or equal to 0.2, less than or equal to 0.15, less than or equal to 0.1, or less than or equal to 0.05. Combinations of the above-referenced ranges are also possible (e.g., greater than or equal to 0.01 and less than or equal to 1.5, greater than or equal to 0.05 and less than or equal to 1.5, or greater than or equal to 0.05 and less than or equal to 0.25). Other ranges are also possible.

While exemplary configurations for substrates having two or more materials, are described above, those skilled in the art would understand based upon the teaching of this specification that additional reconfigurations and rearrangements are also possible (e.g., the third material encapsulating the first and second materials, etc.). Those skilled in the art would also understand, based upon the teachings of this specification, that substrates comprising four or more, five or more, or six or more materials are also possible and that interfaces between any two of the materials may undergo total internal reflection.

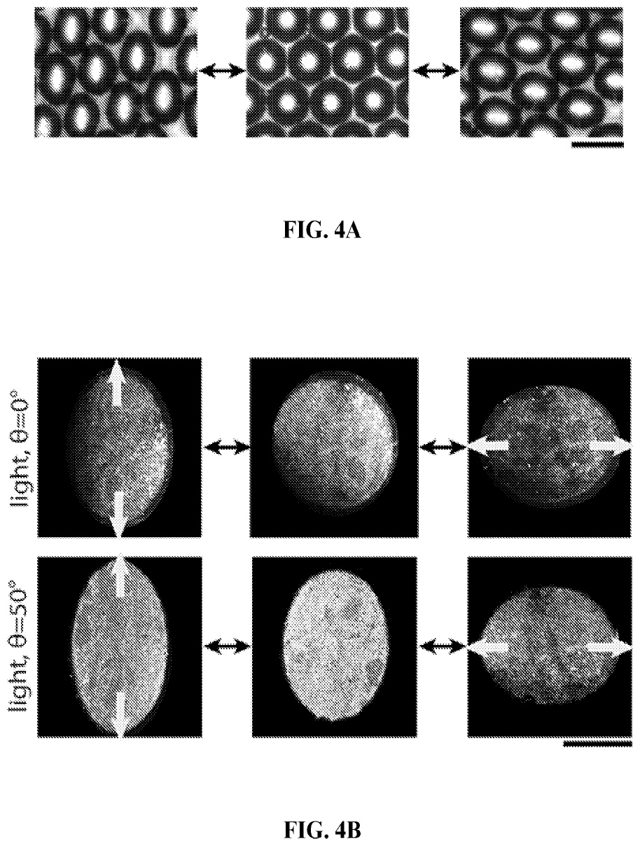

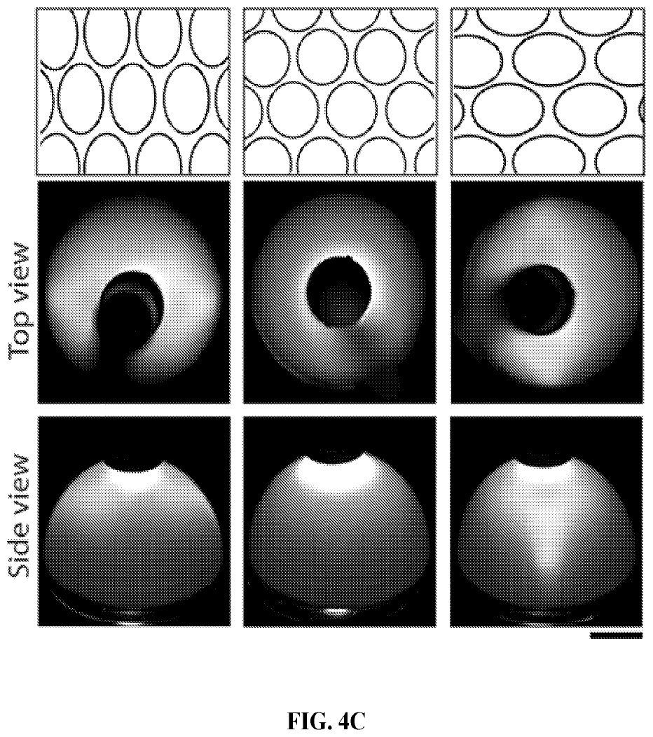

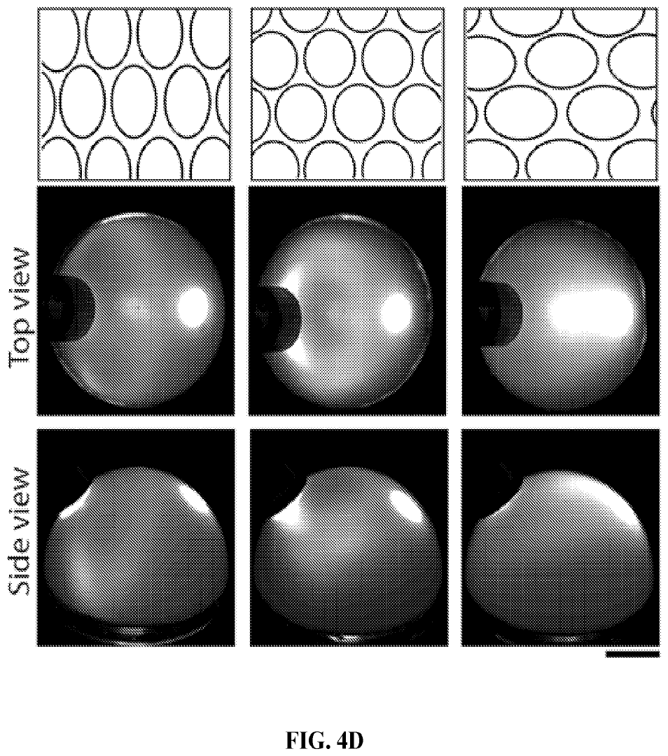

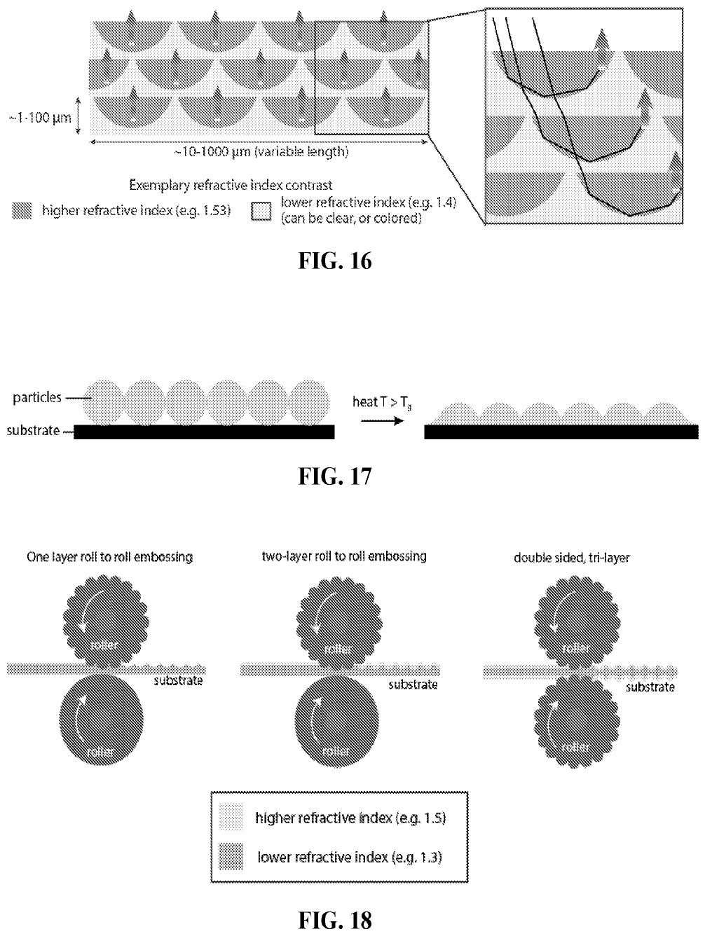

As described above and herein, the plurality of TIR microstructures present within the substrate may be arranged in a two-dimensional or three-dimensional array. The phrase “two-dimensional array” is given its ordinary meaning in the art and generally refers to the ordered arrangement of objects (e.g., domes, wells) in e.g., ordered rows and columns in a two-dimensional plane comprising said objects (see FIGS. 4A-4D). The phrase “three-dimensional array” is given its ordinary meaning in the art and generally refers to the ordered arrangement of objects (e.g., domes, wells) in e.g., ordered rows, columns, and slices (or planes) in a three-dimensional space (see FIG. 16). The arrangement of the wells, and/or domes may be positioned in a disordered array.

In some embodiments, the plurality of TIR microstructures present within the substrate may be randomly distributed (e.g., on a surface, in an outer phase). Advantageously, in some embodiments, the substrates and methods described herein may produce coloration and/or interference without the need for ordered arrangement of the plurality of TIR microstructures present within the substrate.

In some embodiments, at least 10%, at least 20%, at least 30%, at least 40%, at least 50%, at least 60%, at least 70%, at least 80%, or at least 90% of the plurality of TIR microstructures present within the substrate are arranged in a regular two-dimensional array. In some embodiments, less than or equal to 100%, less than or equal to 90%, less than or equal to 80%, less than or equal to 70%, less than or equal to 60%, less than or equal to 50%, less than or equal to 40%, less than or equal to 30%, or less than or equal to 20% of the plurality of TIR microstructures present within the substrate are arranged in a regular two-dimensional array. Combinations of the above-referenced ranges are also possible (e.g., at least 10% and less than or equal to 100%). Other ranges are also possible.

In certain embodiments, at least 10%, at least 20%, at least 30%, at least 40%, at least 50%, at least 60%, at least 70%, at least 80%, or at least 90% of the plurality of TIR microstructures present within the substrate are arranged in a regular three-dimensional array. In some embodiments, less than or equal to 100%, less than or equal to 90%, less than or equal to 80%, less than or equal to 70%, less than or equal to 60%, less than or equal to 50%, less than or equal to 40%, less than or equal to 30%, or less than or equal to 20% of the plurality of TIR microstructures present within the substrate are arranged in a regular three-dimensional array. Combinations of the above-referenced ranges are also possible (e.g., at least 10% and less than or equal to 100%). Other ranges are also possible.

In some embodiments, the TIR microstructures are produced in a templated process such that he TIR microstructures exhibit a low number of defects. Methods which rely, for example, on assembled microspheres, can be prone to defects. By employing the methods described herein, arrays of TIR microstructures can be fabricated with a defect rate (defined as the percent of TIR microstructures which are malformed and/or misplaced within an array of TIR microstructures) or less than 10% (e.g., less than 5%, less than 1%, or less than 0.5%).

The TIR microstructures described herein may have any suitable size. In some embodiments, the TIR microstructures have a largest cross-sectional dimension (e.g., diameter) of less than or equal to 250 microns, less than or equal to 200 microns, less than or equal to 100 microns, less than or equal to 50 microns, less than or equal to 25 microns, less than or equal to 10 microns, less than or equal to 5 microns, or less than or equal to 2 microns. In certain embodiments, the TIR microstructures may have a largest cross-sectional dimension of greater than or equal to 1 micron, greater than or equal to 2 microns, greater than or equal to 5 microns, greater than or equal to 10 microns, greater than or equal to 25 microns, greater than or equal to 50 microns, greater than or equal to 100 microns, or greater than or equal to 200 microns. Combinations of the above-referenced ranges (e.g., greater than or equal to 1 micron and less than or equal to 250 microns) are possible. Other ranges are also possible.

In certain embodiments, at least one of the two or more materials comprises a solid. In some embodiments, both the first material and the second material comprise a solid. Non-limiting examples of suitable solids include polymers, metals, oxides, ceramics, glasses, gels, crystals, carbides, alloys, carbon, ionic solids, and the like. Those of ordinary skill in the art would be capable of selecting suitable solid materials based upon the teachings of this specification (e.g., such that electromagnetic radiation at an interface between a solid material and a second material undergoes total internal reflection).

In some embodiments, at least one of the two or more materials comprises a polymer (e.g., polyethylene glycol, polydimethylsiloxane). In certain embodiments, both the first material and the second material comprise polymers. In certain embodiments, the polymer is a block copolymer. In certain embodiments, the polymer is a liquid crystal polymer (e.g., a thermotropic liquid crystal polymer). In certain embodiments, the polymer is a biopolymer (e.g. gelatin, alginate). Non-limiting examples of suitable polymers include polydimethylsiloxane, polycarbonate, acrylics (e.g., polymethyl methacrylate), polyesters, polyethylene, polyethylene glycol, polyolefins, polypropylene, and polystyrene. Other polymers are also possible and those of ordinary skill in the art would be capable of selecting such polymers based upon the teachings of this specification. In some embodiments, at least one of the two or more materials comprises glass.

In some embodiments, at least one of the two or more materials comprises a hydrocarbon. Non-limiting examples of suitable hydrocarbons include alkanes (e.g., hexane, heptane, decane, dodecane, hexadecane), alkenes, alkynes, aromatics (e.g., benzene, toluene, xylene, benzyl benzoate, diethyl phalate), oils (e.g., natural oils and oil mixtures including vegetable oil, mineral oil, and olive oil), liquid monomers and/or polymers (e.g., hexanediol diacrylate, butanediol diacrylate, polyethylene glycols, trimethylolpropane ethoxylate triacrylate), alcohols (e.g., butanol, octanol, pentanol, ethanol, isopropanol), ethers (e.g., diethyl ether, diethylene glycol, dimethyl ether), dimethyl formamide, acetonitrile, nitromethane, halogenated liquids (e.g., chloroform, dichlorobenzene, methylene chloride, carbon tetrachloride), brominated liquids, iodinated liquids, lactates (e.g., ethyl lactate), acids (e.g., citric acid, acetic acid), liquid crystals (4-cyano-4′-pentylbiphenyl), trimethylamine, liquid crystal hydrocarbons (e.g., 5-cyanobiphenyl), combinations thereof, and derivatives thereof, optionally substituted. In some embodiments, the hydrocarbon comprises a halogen group, sulfur, nitrogen, phosphorus, oxygen, or the like. Other hydrocarbons are also possible.

In some embodiments, at least one of the two or more materials comprises a fluorocarbon. Non-limiting examples of suitable fluorocarbons include fluorinated compounds such as perfluoroalkanes (e.g., perfluorohexanes, perfluorooctane, perfluorodecalin, perfluoromethylcyclohexane), perfluoroalkenes (e.g., perfluorobenzene), perfluoroalkynes, and branched fluorocarbons (e.g., perfluorotributylamine). Additional non-limiting examples of suitable fluorocarbons include partially fluorinated compounds such as methoxyperfluorobutane, ethyl nonafluorobutyl ether, 2H,3H-perfluoropentane, trifluorotoluene, perfluoroidodide, fluorinated or partially fluorinated oligomers, 2,2,3,3,4,4,5,5,6,6,7,7,8,8,9,9-hexadecafluorodecane-1,10-diyl bis(2-methylacrylate), perfluoroiodide, and 2-(trifluoromethyl)-3-ethoxydodecafluorohexane. Other fluorocarbons are also possible.

In some embodiments, at least one of the two or more materials comprises a silicone such as silicone oil. Non-limiting examples of suitable silicone oils include polydimethylsiloxane and cyclosiloxane fluids.

In some embodiments, at least one of the two or more materials comprises water.

In some embodiments, at least one of the two or more materials comprises an ionic liquid (e.g., an electrolyte, a liquid salt). In some embodiments, at least one of the two or more inner materials comprises an ionic liquid (e.g., an electrolyte, a liquid salt, 1-allyl-3-methylimidazolium bromide, 1-allyl-3-methylimidazolium chloride, 1-benzyl-3-methylimidazolium hexafluorophosphate, 1-butyl-1-methylpyrrolidinium hexafluorophosphate). In some embodiments, the outer material comprises water.

In some embodiments, at least one of the two or more materials comprises a gas (e.g., a perfluoropentane gas, oxygen gas, nitrogen gas, helium gas, hydrogen gas, carbon dioxide gas, air).

When present, the third material can comprise any suitable material. In some embodiments, the third material is a solid. In certain embodiments, the third material is a liquid. In some embodiments, the third material is a gel or a solid. In some embodiments, the third material is an aqueous material (e.g., comprising water, a hydrocarbon, a fluorocarbon). In certain embodiments, the third material is a non-aqueous material (e.g., comprising a silicone, comprising a polymer, comprising an elastomer, comprising a glass). In an exemplary embodiment, the third material is a polymer. In another exemplary embodiment, the third material is an elastomer. In yet another exemplary embodiment, the third material is a glass. In some embodiments, the third material is transparent (e.g., to a particular wavelength of electromagnetic radiation such as visible light) such that a particular wavelength of electromagnetic radiation (e.g., visible light) may be transmitted through the third material and interact with the plurality of interface described herein.

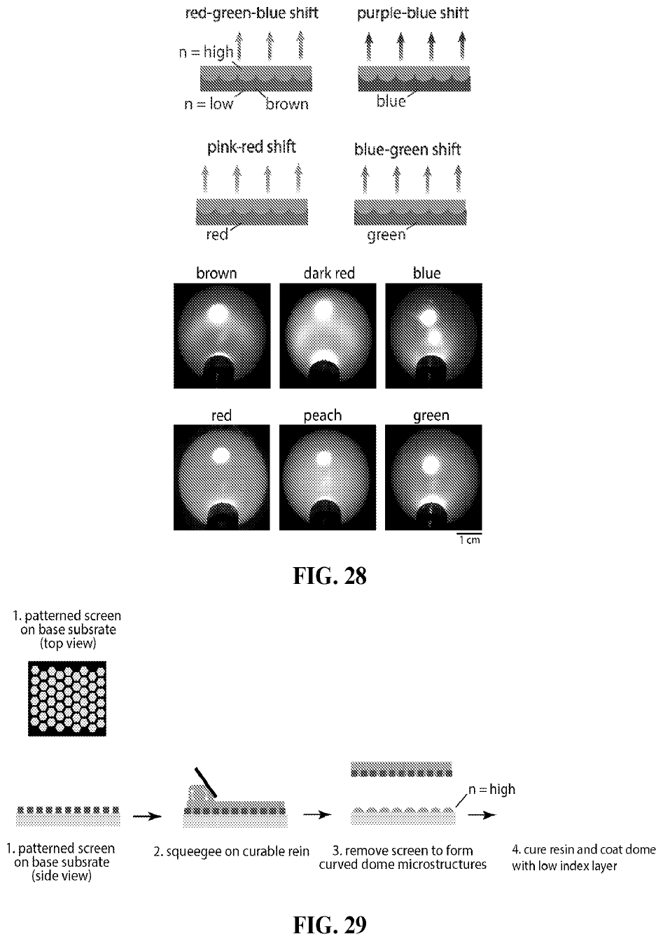

In some embodiments, the first material, the second material, the third material, or any combination thereof can further comprise an additive that alters one or more optical properties of the material (e.g., the absorption, transmission, refractive index, or any combination thereof of the material). In this way, the observed optical effects can be modulated. By way of example, in some embodiments, the first material, the second material, the third material, or any combination thereof can further comprise a pigment to modulate, for example, structural color exhibited by the substrate (see FIG. 28). In certain embodiments, the low index material can include one or more pigments.

Methods of Making Substrates

Provided herein are methods of making substrates that exhibit an interference pattern upon reflection of incident electromagnetic radiation. These methods can employ, for example, photolithographic patterning and microstructure mold making and replication processes which are scalable to allow for the fabrication of such substrates on a commercial scale (e.g., using continuous processes such as reel-to-reel embossing methods). Example methods are illustrated in FIGS. 17-31 and discussed in more detail below.

Methods for forming substrates that exhibit an interference pattern upon reflection of incident electromagnetic radiation (e.g., structural coloration) can comprise providing an interface master having the geometrical form of a plurality of total internal reflection (TIR) microstructure templates formed therein. Optionally, providing the interface master can comprise forming the interface master. The interface master has the geometrical form of a plurality of total internal reflection (TIR) microstructure templates formed therein, meaning that a surface of the interface master has surface structures shaped to produce a plurality TIR microstructures on the first material. In some embodiments, the surface of the interface master can have surface structures that are identical to the negative of the TIR microstructures to be formed on the first material. Methods can further comprise generating a microreplicated surface on a first material having a first refractive index from the interface master. The resulting microreplicated surface corresponds to and is a negative of the interface master. Subsequently, a suitable second material having a second refractive index can be disposed on the microreplicated surface to produce a substrate that exhibits an interference pattern upon reflection of incident electromagnetic radiation (e.g., that exhibits structural coloration). The resulting substrate comprises a plurality of TIR microstructures, each of which comprises the first material, the second material abutting the first material, and an interface between the first material and the second material. As discussed above, the interface is configured such that at least a portion of electromagnetic radiation incident a surface of the substrate at at least one illumination angle undergoes multiple total internal reflections between the first material and the second material.

An interface master having the geometrical form a plurality of TIR microstructure templates formed therein can be prepared by a variety of processes, including laser etching, laser deposition, photolithography, chemical etching, nickel electroforming, 3D printing, or combinations thereof. In some embodiments, the interface master can comprise a hard master, as described below. In other embodiments, the interface master can comprise a soft master.

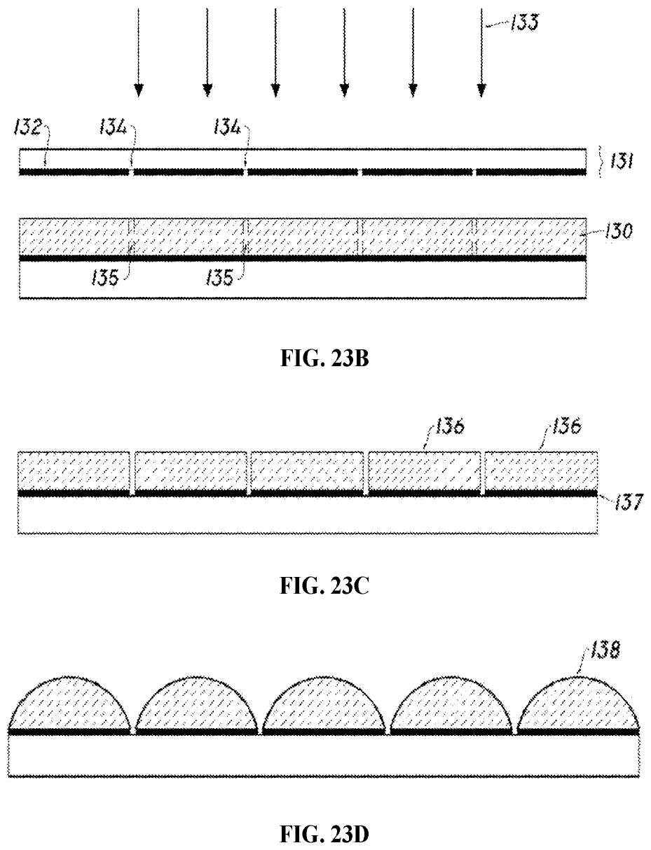

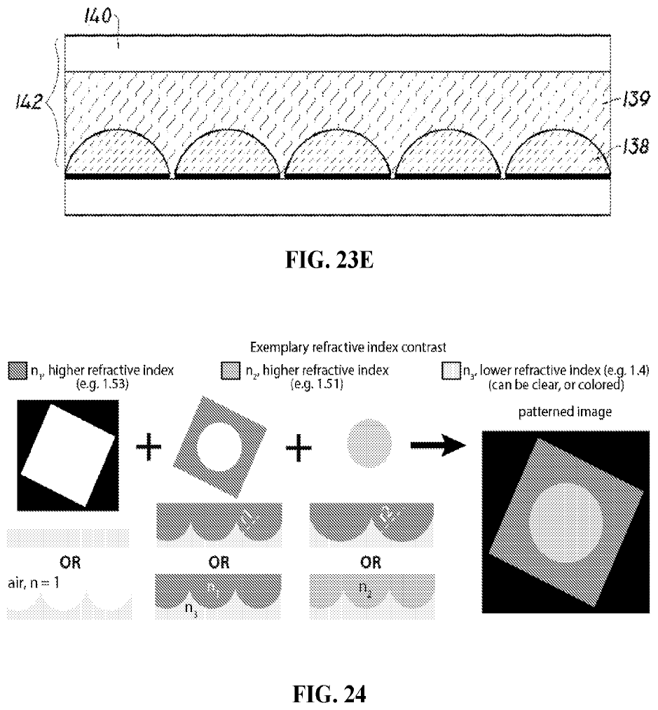

An example method for fabricating an interference master using photolithography is illustrated in FIGS. 23A-23E. FIG. 23A illustrates a smooth glass substrate 128 which is covered by a layer of aluminum 129. On top of the aluminum 129, a layer of positive photoresist 130 is deposited. A chrome on glass photomask 131 with a curvature array pattern 132 is placed in contact with the photoresist 130, as shown in FIG. 23B. The structure is then exposed using collimated ultraviolet light 133, through the clear areas in the mask 134, allowing exposure of the photoresist only in the locations where photoresist is to be removed 135. The glass with photoresist is then placed in caustic developer solution so that the exposed areas are washed away along with the underlying aluminum. The result is photoresist cylinders 136 sitting on aluminum bases 137, where the bases will act as a boundary region that prevents the photoresist from wetting to the glass after heating, as shown in FIG. 23C.

Next the glass is placed on a hotplate in order to melt the photoresist, creating shaped curvature structures 138 from the surface tension of the molten resist, as shown in FIG. 23D. Once cooled, a liquid photopolymer 139 is applied to the surface of the resist shapes 138, as shown in FIG. 23E, followed by a new glass cover substrate 140. The photopolymer is then hardened by flood exposure to ultraviolet light and lifted away from the photoresist structures. The result is soft master that includes an array of concave curvature shapes in photopolymer attached to a new glass substrate.

Suitable masters can also be prepared through the self-assembly and subsequent manipulation of particles. For example, an array of spherical particles (e.g., polymer particles) can be ordered on a suitable surface. Following self-assembly of the particles into an array, the spherical particles can be heated to a temperature above the glass transition temperature of the spherical particles. Upon heating, the particles can deform, forming an array of hemispherical domes on the surface. This strategy is schematically illustrated in FIG. 17.

In a related method, an array of particles (e.g., glass beads or polymer particles) can be ordered at an interface. The interface can be, for example, a solid-gas interface (e.g., a surface of a glass or polymer substrate in air), a solid-liquid interface (e.g., a surface of a glass or polymer substrate immersed in water), or a liquid-liquid interface (e.g., an oil-water interface, or an interface between a liquid and an immiscible curable resin). If necessary, the surface or the particles can be functionalized to drive assembly at the interface. Following self-assembly of the particles into an array, the array of particles can then be fixed within a base material, thereby forming an interface master comprising an array of TIR microstructure templates. In some embodiments, the base material can comprise a curable resin. In these examples, fixing the population of particles within a base material can comprise curing the particles in the curable base material. In other embodiments, the base material can comprise a defomable material (such as a deformable polymer). In these examples, fixing the population of particles a base material can comprise impressing the particles into a deformable base material.

If desired, the base material can be treated (e.g., by heating or swelling the base material) to facilitate deformation of the base material and/or embedding of the particles in the base material. For example, in some embodiments, the base material can comprise a thermoplastic polymer substrate, and impressing the particles can comprise heating the thermoplastic polymer substrate (e.g, to a temperature above the Tg of the thermoplastic substrate) and impressing the particles into the thermoplastic substrate. In other embodiments, the base material can comprise a polymer substrate, and impressing the particles can comprise contacting the polymer substrate with a solvent to swell and/or soften the polymer substrate, and impressing the particles into the polymer substrate.

These methods generally result in soft masters, meaning a few replicas of their surfaces can be made (e.g., by filling the soft master with a curable composition, curing the composition, and removing the cured composition of the soft master) before damage is incurred. For a more robust mold, for example that can be used for mass production of substrates by hard or soft embossing, a hard master can be prepared and used.

A hard master is durable embossing mold (e.g., an embossing mold fabricated from a metal, ceramic, or high durometer polymer) having a negative version of the desired microstructure, so that when its surface is replicated by embossing or casting, a positive version of the structure may be produced. A hard master can be formed by conductive metallization and electroforming, as is known in the art of DVD manufacturing. By way of example, the soft master can be coated with a thin layer of silver by vapor deposition, provided with electrical contact, and placed in nickel plating solution for electrodeposition. After a sufficient thickness of nickel has plated the surface (for example ¼ or ½ mm in thickness), the plated structure is removed from the solution. The electroformed hard master can then be peeled away from the soft master. A nearly unlimited number of soft embossments of the hard master's surface can then be made from the surface of the hard master, provided the surface of the hard master remains unscratched or unabraided.

The hard master structure can also be copied onto further hard masters having mirrored structure if the electroforming process is repeated. In DVD mastering, the first nickel master is called the father, and the copies from the father surface are referred to as mothers. The mother can be used in production only if a mirror image of the original is desired. This can be useful if it is desired to switch between concave and convex structures, though text and nonsymmetrical images will be reversed. Otherwise, the mother electroform can be used to generate another electroform known as the son, which will have the same structure as the father, from which soft replicas or embossments can be made that match the structure of the original soft master.

If desired, to facilitate the mass production of substrates using conventional industrial printing equipment, the hard master father or son can be formed into a cylinder around a rigid core, so as to form a hard embossing cylinder. This cylinder can be used, for example, to continuously impress microstructures into a web fed substrate by heated embossing, or to cast the microstructures onto a substrate surface using a curable polymer resin, such as an energy curable acrylate resin.

The hard master can made from electroformed nickel, but is not limited by the material used, as this can vary depending on production requirements. For example, master molds can be made from electroformed copper, or from modern rigid epoxies for light duty manufacturing. A master mold can also be formed by an additive manufacturing process such as 3D printing, provided the resolution is high enough. The print could be used directly or used to make further hard masters.

For heavy duty applications, such as high pressure stamping, a high hardness master die may be needed. To create such a tool, a nickel master mother can be coated with a first soft metal such as silver, which will act as a release layer. Next a layer of titanium nitride can be applied to the surface of the silver, which will impart superior hardness to the final master. The mother may then be placed inside a graphite die mold and the entire assembly heated to reduce effect of thermal shock. Molten carbon steel is then poured into the die mold, onto the face of the TiN coated mother. This can then be allowed to cool slowly or can be heat treated by quenching rapidly in oil to impart a high hardness. Upon cooling, the mold can be broken away, the backside of the steel planarized, and the mother peeled away from the cast steel die, separating at the silver interface. The hardened steel die having a thin layer of titanium nitride can be suitable for some applications where heavy duty stamping or metal casting is employed.

Interface masters can also be fabricated using a variety of 3D printing processes known in the art. Suitable methods can be selected in view of a variety of factors, including the type of master being formed (e.g., a soft master or a hard master) and the dimensions of the TIR microstructure templates to be formed. Any suitable additive manufacturing process may be used, including methods that involve, for example, vat polymerization, material jetting, binder jetting, powder bed fusion, material extrusion, directed energy deposition, or sheet lamination. Examples of additive manufacturing processes include fused deposition modeling, fusted filament fabrication, fused pellet fabrication, fused particle fabrication, robocasting, composite filament fabrication, stereolithography, digital light processing, continuous liquid interface production, powder bed and inkjet head 3D printing, electron-beam melting, selective kaster melting, selective heat sintering, selective laser sintering, direct metal laser sintering, direct energy deposition, electron beam freeform fabrication, multiphoton lithography, and laminated object manufacturing. Following 3D printing of TIR microstructure templastes, post-processing steps can be employed, for example, to smooth regions of the microstructure templates and eliminate defects. This can involve, for example, thermal and/or solvent reflow to eliminate any surface roughness resulting from the additive manufacturing process. In some embodiments, the surface of the TIR microstructure templates can be treated, for example, with UV irradiation or plasma treatment to improve susceptibility of the surface to thermal and/or solvent reflow.

Microreplication of the plurality of TIR microstructures using the interface master can be accomplished using a variety of suitable methods. In certain embodiments, generating the microreplicated surface on the first material can comprise an embossing process. The embossing process can comprise, for example, plate-to-plate embossing, roll-to-plate embossing, or roll-to-roll embossing of the first material. In certain embodiments, the embossing process can be performed in a reel-to-reel, continuous process. Such methods are illustrated in FIGS. 18, 19, and 20.

If desired, a vacuum may be applied during the embossing process to deform the first material over the interface master. Heat may also be used during the embossing process. In such cases, typically the interface master is heated; however, the interface master, the first material, or any combination thereof may be heated before and/or during the embossing process. In some embodiments, the first material (e.g., a thermoplastic polymer) can have a glass transition temperature (T_{g}) (e.g., a T_{g} of at least 50° C., at least 60° C., at least 70° C., at least 80° C., at least 90° C., at least 100° C., at least 110° C., at least 120° C., at least 130° C., at least 140° C., at least 150° C., at least 160° C., at least 170° C., or at least 180° C.), and the embossing can be conducted at temperatures above the T_{g} of the first material so that the first material more easily flows into the interface master (e.g., a hot embossing process). The structure of the first material then becomes fixed when cooled below T_{g}.

Alternative methods can also be used, such as a cast and cure process. In such methods, a curable resin in deposited on a carrier, where it is patterned using the interface master and cured (e.g., using actinic radiation) before the interface master is removed. This cast and cure process can also be done in a continuous manner using a roll of carrier, depositing a layer of curable material onto the carrier, laminating the curable material against an interface master and curing the curable material using actinic radiation. Injection molding can also be used to form the microreplicated surface.

In another embodiments, microreplication can involve 3D printing of TIR microstructures (e.g., on a suitable substrate). Any suitable additive manufacturing process may be used, including methods that involve, for example, vat polymerization, material jetting, binder jetting, powder bed fusion, material extrusion, directed energy deposition, or sheet lamination. Examples of additive manufacturing processes include fused deposition modeling, fusted filament fabrication, fused pellet fabrication, fused particle fabrication, robocasting, composite filament fabrication, stereolithography, digital light processing, continuous liquid interface production, powder bed and inkjet head 3D printing, selective heat sintering, selective laser sintering, multiphoton lithography, and laminated object manufacturing. Following 3D printing of TIR microstructures, post-processing steps can be employed, for example, to smooth regions of the microstructures and eliminate defects. This can involve, for example, thermal and/or solvent reflow to eliminate any surface roughness resulting from the additive manufacturing process. In some embodiments, the surface of the TIR microstructures can be treated, for example, with UV irradiation or plasma treatment to improve susceptibility of the surface to thermal and/or solvent reflow.

Once the microreplicated surface has been formed, the second material can be disposed on the microreplicated surface using any suitable method, such as knife coating, dip coating, spray coating, printing (e.g., ink jet printing), sputtering, evaporating, or spin coating the second material on the embossed surface. Suitable methods can be selected in view of a number of factors, including the nature of the microreplicated surface, the nature of the second material, and overall compatability with the manufacturing process.

In some embodiments, disposing the second material on the microreplicated surface can comprise immersing the substrate in the second material. In cases where the second material is a liquid, disposing the second material on the microreplicated surface can comprise placing the substrate in the liquid such that the microreplicated surface is intimately contacted with the second material (e.g., dipping or dispersing the substrate in the liquid). In cases where the second material is a gas, disposing the second material on the replicated surface can comprise placing the substrate in an atmosphere of comprising the gas (or in a vacuum).

In some embodiments, disposing the second material on the microreplicated surface can comprise growing or precipitating the second material (e.g., an inorganic material such as MgF₂, SiO₂, TiO₂, or Al₂O₃. In some embodiments, the second material can comprise a curable resin (e.g., a UV curable resin or a thermosetting resin). In these embodiments, methods of of disposing the second material can comprise applying the second material by any suitable method, and curing the resin (e.g., by irradiating and/or heating the second material to cure the second material). In some embodiments, disposing the second material on the microreplicated surface can form a conformal coating encasing some or all of the substrate.

Various methods may be used to pattern the substrate during fabrication. In some embodiments, the second material (or combination of different second materials) can be patterned on the microreplicated surface (e.g., to generate logos, designs, shapes, lettering, etc.). See FIG. 24. For example, a first coating material can be disposed on a first region of the microreplicated surface to produce the first region of the substrate that exhibits an interference pattern upon reflection of incident electromagnetic radiation; and a second coating material can be disposed on a second region of the microreplicated surface to produce the second region of the substrate that exhibits differential structural coloration. The first coating material and the second coating material can differ in one or more optical properties. For example, in some embodiments, the first coating material and the second coating material can absorption, transmission, refractive index, or any combination thereof. In some cases, the first coating material and the second coating material can be different materials selected to differ in terms of their refractive indices. In other cases, a pigment or other additive can be incorporated in the first coating material, the second coating material, or a combination thereof to, for example, alter the absorption of the coating and/or the transmission of the coating. As a consequence of these differential optical properties, the resulting substrate includes a first region and a second region that each include a plurality of TIR microstructures that exhibit different interference pattern upon reflection of incident electromagnetic radiation. In some embodiments, the first coating material exhibits substantially the same optical properties as the first material, such that regions coated with the first coating materials do not exhibit total internal reflection with regions coated with the second coating materials exhibit total internal reflection.

In some embodiments, a region of the microreplicated surface may be deformed prior to disposing the second material on the microreplicated surface, such that the region where the microreplicated surface was deformed does not exhibit multiple total internal reflections. In this way, a pattern can be formed from the contrast formed between regions of the substrate that exhibit multiple total internal reflections and regions of the substrate that do not.

In some embodiments, these methods can be repeated to form a second plurality of TIR microstructures on or within the substrate. In some embodiments, this can comprise forming a second plurality of TIR microstructures (e.g., having different dimensions and/or different constituent materials) in a second region of the first material (so as to generate a substrate that includes a first region and a second region that each include a plurality of TIR microstructures that exhibit different interference pattern upon reflection of incident electromagnetic radiation). In this way, patterns can be formed across a substrate surface (e.g., to generate logos, designs, shapes, lettering, etc.). See FIG. 24.

In some embodiments, the first material can be strained or otherwise physically deformed prior to disposing a second material on the first material. Strain can be used, when desired, to introduce asymmetry into TIR microstructures.

In some embodiments, methods can comprise casting an additional base material (e.g., an additional layer of a first material) on top of the second material. The methods described above (e.g., generating a second microreplicated surface on the additional later of first material and then disposing an additional second material on the second microreplicated surface) can then be repeated (if desired again and again) to generate a multilayer (three-dimensional) array of TIR microstructures. See FIGS. 16, 26, and 27.

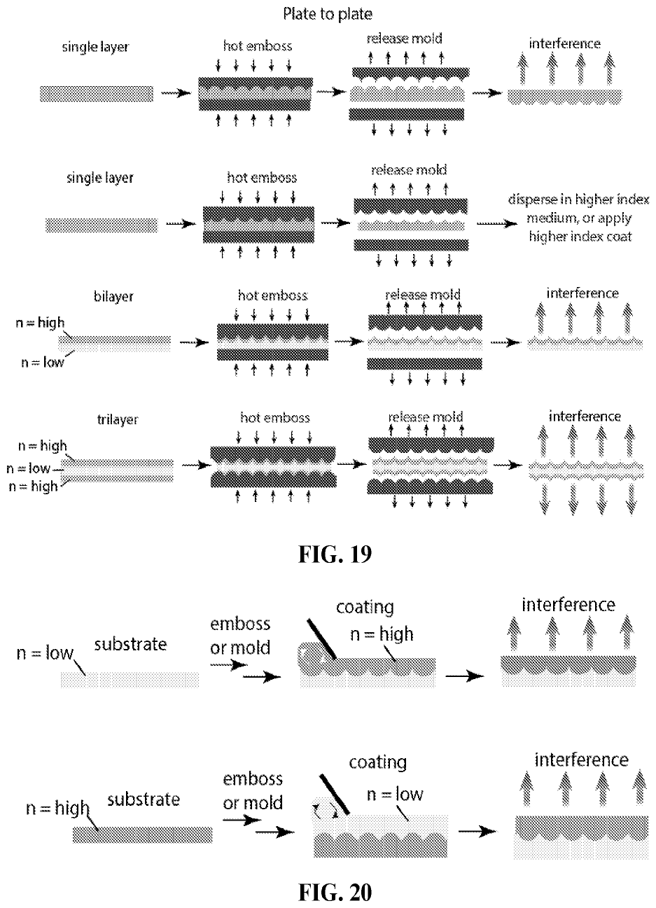

Also provided are related methods of producing substrates that exhibit an interference pattern upon reflection of incident electromagnetic radiation by embossing a bilayer material. Such methods are illustrated, for example, in FIGS. 18 and 19. These methods can comprise providing an interface master having the geometrical form of a plurality of total internal reflection (TIR) microstructure templates formed therein, and embossing a bilayer material using the interface master to produce the substrate that exhibits an interference pattern upon reflection of incident electromagnetic radiation. The substrate comprises a plurality of TIR microstructures, each of which comprises the first material, the second material abutting the first material, and an interface between the first material and the second material. The interface corresponds to and is a negative of the interface master, and is configured such that at least a portion of electromagnetic radiation incident a surface of the substrate at at least one illumination angle undergoes multiple total internal reflections between the first material and the second material.

The bilayer material can comprise a first layer formed from a first material having a first refractive index and a second layer abutting the first layer and formed from a second material having a second refractive index. In some embodiments, the first material can comprise a first polymer and the second material can comprise a second polymer. For example, the first polymer and the second polymer can each comprise a thermoplastic, such as a polyester, a polyolefin, acrylic, acrylonitrile butadiene styrene (ABS), a polyamide, or any combination thereof.

Also provided are related methods of producing substrates that exhibit an interference pattern upon reflection of incident electromagnetic radiation by embossing a multilayer material. Such methods are illustrated, for example, in FIGS. 18 and 19. These methods can comprise providing a pair of interface masters, each having the geometrical form of a plurality of total internal reflection (TIR) microstructure templates formed therein, and embossing a multilayer material between the pair of interface masters to produce the substrate that exhibits an interference pattern upon reflection of incident electromagnetic radiation.

The resulting substrate can comprise a first array of TIR microstructures, each of which comprises the first material, the second material abutting the first material, and a first interface between the first material and the second material; and a second array of TIR microstructures, each of which comprises the first material, the third material abutting the first material, and a second interface between the first material and the third material. The first interface and the second interface correspond to and are a negative of the pair of interface masters. The first interface is configured such that at least a portion of electromagnetic radiation incident a surface of the substrate at at least one illumination angle undergoes multiple total internal reflections between the first material and the second material; and the second interface is configured such that at least a portion of electromagnetic radiation incident a surface of the substrate at at least one illumination angle undergoes multiple total internal reflections between the second material and the third material.

In some cases, the pair of interface masters each have a different geometrical form of a plurality of total internal reflection (TIR) microstructure templates formed therein. In these embodiments, TIR microstructures having different geometries can be formed using each of the interface masters (e.g., on opposing faces of the substrate). In other cases, the pair of interface masters each have the same geometrical form of a plurality of total internal reflection (TIR) microstructure templates formed therein. In these embodiments, TIR microstructures having identical geometries can be formed using each of the interface masters (e.g., on opposing faces of the substrate).

The multilayer can comprise, for example a trilayer material or a four-layer material. In some example, the multilayer material comprises a core layer formed from a first material having a first refractive index, a top layer abutting the core layer and formed from a second material having a second refractive index, and a bottom layer abutting the core layer and formed from a third material having a third refractive index. In some embodiments, the core layer can comprise a single layer material (i.e., the material comprises a trilayer material). In other embodiments, the core layer can comprise a bilayer material (i.e., the material comprises a four-layer material). In some embodiments, the second material and the third material can comprise the same material. In other embodiments, the second material and the third material can comprise different materials. In some embodiments, the first material can comprise a first polymer, the second material can comprise a second polymer, and the third material can comprise a third polymer. For example, the first polymer, the second polymer, and the third polymer can each comprise a thermoplastic, such as a polyester, a polyolefin, acrylic, acrylonitrile butadiene styrene (ABS), a polyamide, or any combination thereof.

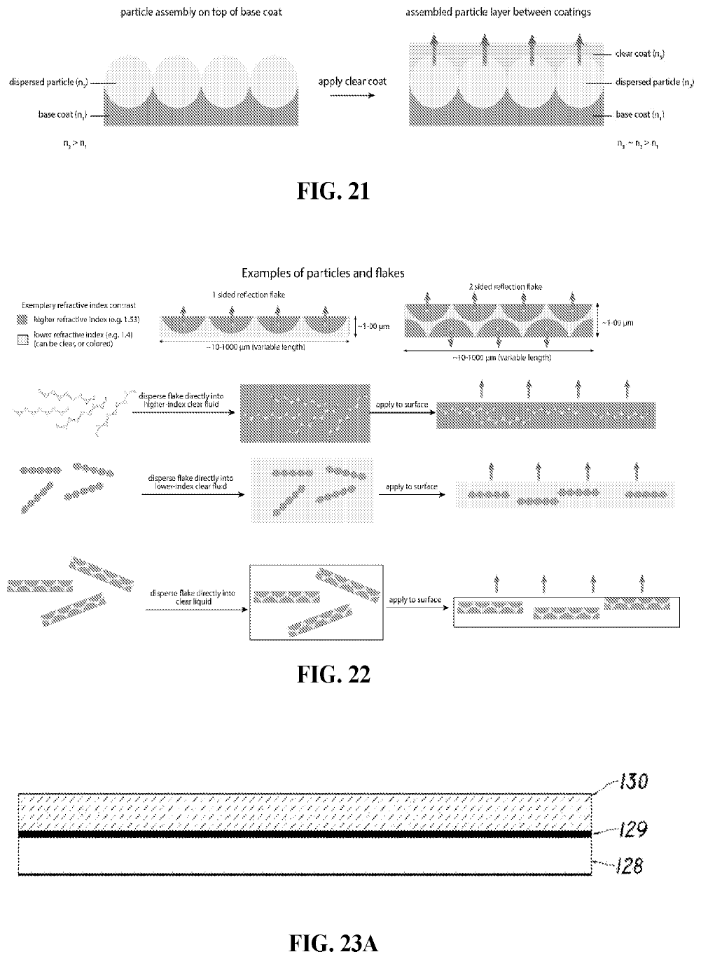

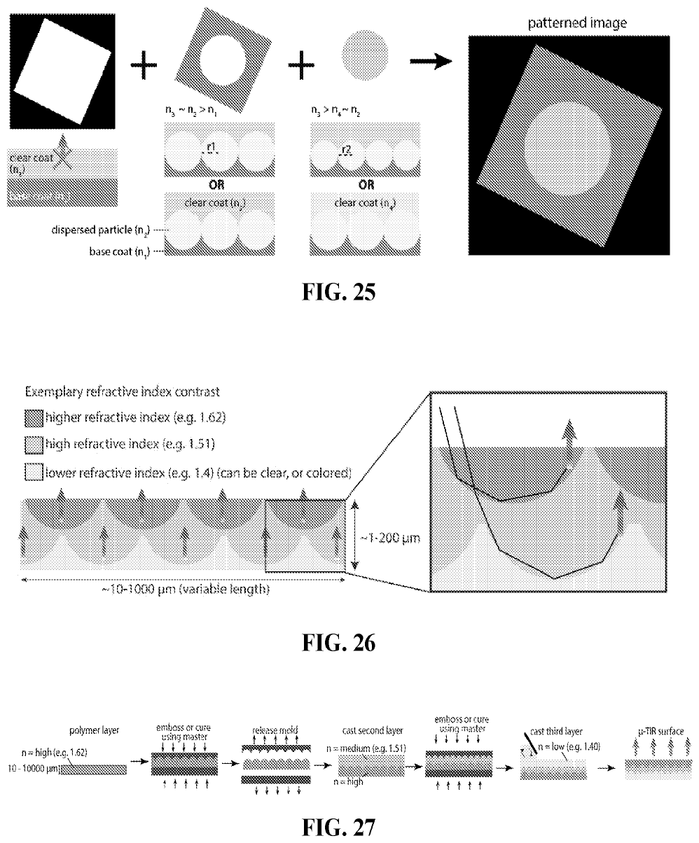

Also provided are methods of forming substrates that exhibit an interference pattern upon reflection of incident electromagnetic radiation using particles. For example, provided are methods of forming substrates that comprise fixing a population of particles formed from a first material having a first refractive index within a base material having a second refractive index, thereby forming an array of TIR microstructures, each of which comprises the first material, the base material abutting the first material, and an interface between the first material and the base material. The interface is configured such that at least a portion of electromagnetic radiation incident a surface of the substrate at at least one illumination angle undergoes multiple total internal reflections between the first material and the coating material. Such methods are illustrated, for example, in FIGS. 21 and 25.

If desired, multiple populations of particles (e.g., having different optical properties and/or dimensions so as to provide different interference patterns upon reflection of incident electromagnetic radiation) can be fixed using the method described above. For example, in some embodiments, a first population of particles can be fixed within a first region of the base material and a second population of particles can be fixed within a second region of the base material. As a consequence, substrates that exhibit different interference pattern upon reflection of incident electromagnetic radiation). In this way, patterns can be formed across a substrate surface (e.g., to generate logos, designs, shapes, lettering, etc.). See FIG. 25. In other embodiments, two populations of particles can be mixed and fixed in the same region of the base material so as to provide an interference pattern that is the aggregate of the interference pattern of the pattern provided by the first population and second population of particles individually.

In some embodiments, fixing the population of particles within a base material can comprise curing the particles in curable base material. In other embodiments, fixing the population of particles within a base material can comprise impressing the particles into a deformable base material.

If desired, the base material can be treated (e.g., by heating or swelling the base material) to facilitate deformation of the base material and/or embedding of the particles in the base material. For example, in some embodiments, the base material can comprise a thermoplastic polymer substrate, and impressing the particles can comprise heating the thermoplastic polymer substrate (e.g, to a temperature above the Tg of the thermoplastic substrate) and impressing the particles into the thermoplastic substrate. In other embodiments, the base material can comprise a polymer substrate, and impressing the particles can comprise contacting the polymer substrate with a solvent to swell and/or soften the polymer substrate, and impressing the particles into the polymer substrate.

In some embodiments, the population of particles can be substantially monodisperse in size. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the mean particle size (e.g., within 20% of the mean particle size, within 15% of the mean particle size, within 10% of the mean particle size, or within 5% of the mean particle size).

In some embodiments, the population of particles can have an average particle size of less than about 500 microns (e.g., less than about 450 microns, less than about 400 microns, less than about 350 microns, less than about 300 microns, less than about 250 microns, less than about 200 microns, less than about 150 microns, less than about 100 microns, less than about 50 microns, less than about 25 microns, less than about 10 microns, or less than about 5 microns). In some embodiments, the population of particles can have an average particle size of at least about 2 microns (e.g., at least about 5 microns, at least about 10 microns, at least about 25 microns, at least about 50 microns, at least about 100 microns, at least about 150 microns, at least about 200 microns, at least about 250 microns, at least about 300 microns, at least about 350 microns, at least about 400 microns, or at least about 450 microns).

The population of particles can have an average particle size ranging from any of the minimum values described above to any of the maximum values described above. For example, in some embodiments, the population of particles can have an average particle size ranging from about 2 microns to about 500 microns (e.g., from about 5 microns to about 250 microns, or from about 5 microns to about 150 microns).

The degree of embeddedness of a particle can be defined in terms of the amount of the surface area of the particle that is covered by (e.g., in contact with) the base material. For example, a particle having 50% of its surface area embedded within the base material will be said to have a degree of embeddedness of 50%. The embeddedness of particles can be assessed by optical profilometry. In some embodiments, the population of particles exhibits an average degree of embeddedness within the base material of at least 5% (e.g., at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90%) as measured using optical profilometry. In some embodiments, the population of particles exhibits an average degree of embeddedness within the base material of 95% or less (e.g., 90% or less, 85% or less, 80%, or less, 75% or less, 70%, or less, 65% or less, 60%, or less, 55% or less, 50%, or less, 45% or less, 40%, or less, 35% or less, 30%, or less, 25% or less, 20%, or less, 15% or less, or 10%, or less) as measured using optical profilometry.

The population of particles can exhibit an average degree of embeddedness within the base material ranging from any of the minimum values described above to any of the maximum values described above. For example, in some embodiments, the population of particles exhibits an average degree of embeddedness within the base material of from 5% to 95%, as measured using optical profilometry. In some embodiments, the population of particles exhibits an average degree of embeddedness within the base material of from 5% to 60%. In other embodiments, the population of particles exhibits an average degree of embeddedness within the base material of from 40% to 95%.

In some embodiments, the particles can exhibit a monodisperse degree of embeddeness, as measured using optical profilometry. A population of particles can be said to exhibit a monodisperse degree of embeddedness when 80% of the particles (e.g., 85% of the particles, 90% of the particles, or 95% of the particles) exhibit a degree of embeddedness within 25% of the mean degree of embeddedness (e.g., within 20% of the mean degree of embeddedness, within 15% of the mean degree of embeddedness, within 10% of the mean degree of embeddedness, or within 5% of the mean degree of embeddedness).

In some embodiments, these methods can be repeated to form a second plurality of TIR microstructures on or within the substrate. In some embodiments, this can comprise fixing a second population of particles (e.g., having different dimensions and/or different constituent materials) in a second region of the base material (so as to generate a substrate that includes a first region and a second region that each include a plurality of TIR microstructures that exhibit different interference pattern upon reflection of incident electromagnetic radiation). In this way, patterns can be formed across a substrate surface (e.g., to generate logos, designs, shapes, lettering, etc.). See FIG. 25.

Similar substrates can also be formed by dispersing Janus particles in a suitable matrix to form a substrate. Examples of Janus particles, as well as methods of making such particles, are described, for example, in U.S. Patent Application No. 2018/0246314 to Swager et al., which is incorporated herein by reference in its entirety. The Janus particles can be aligned within the matrix such that the substrate exhibits an interference pattern upon reflection of incident electromagnetic radiation when viewed from a viewing angle. The particle can be aligned using a variety of suitable methods, including applying an external stimulus (e.g., an electric field or a magnetic field) to align the particles, incorporating differences in density throughout the particle (so as to facilitate alignment of the particles, for example, during settling/curing of the matrix), incorporating difference in particle shape/geometry (e.g., utilizing plate-shaped particles which naturally align during settling/curing of the matrix), or exploiting differences in the wettability of different surfaces of the particles.

Also provided are methods of forming substrates that exhibit an interference pattern upon reflection of incident electromagnetic radiation using a screen printing process. Such methods are illustrated, for example, in FIG. 29. These methods can involve applying a curable resin (e.g., a radiation-curable resin) through a patterned screen or mesh (e.g., a metal screen or mess) positioned on a substrate. Application of the resin can comprise, for example, doctor blading or otherwise coating the curable resin on the patterned screen or mesh. The patterned screen or mesh can include an array of openings defined by mesh threads. In some embodiments, the openings can have an average size (e.g., an average largest horizontal cross-sectional dimension) that is at least 2.5 times larger than the mesh thread spacing. The openings in the screen or mesh may be patterned (in size and/or in relative orientation within the array) using standard microfabrication techniques (e.g., using a capillary film and patterned photoresist). In some embodiments, the openings in the mesh or screen can be positioned in a hexagonal array with a 20% spacing in between each opening.

After applying the resin through the patterned screen or mesh onto the substrate, the screen can be removed. Wetted sessile droplets of curable resin can remain affixed to the substrate in an arrayed pattern determined by the pattern of openings in the screen or mesh. The contact angle/radius of curvature of the resin droplet can be determined by of the interplay between the surface energy of the resin, the surface energy of the substrate, and/or the surface energy of the air. Tuning the resin composition and/or substrate surface properties can be used to adjust the contact angle and curvature of the microstructure to control the possible TIR paths of reflecting light. The resin can then be cured to form a patterned substrate containing solid dome microstructures. The resulting article may then be coated with a lower index material so that a concave interface is formed capable of TIR or it may serve as a mold to replicated and transferred into other materials for later replication using different techniques other than screen printing.

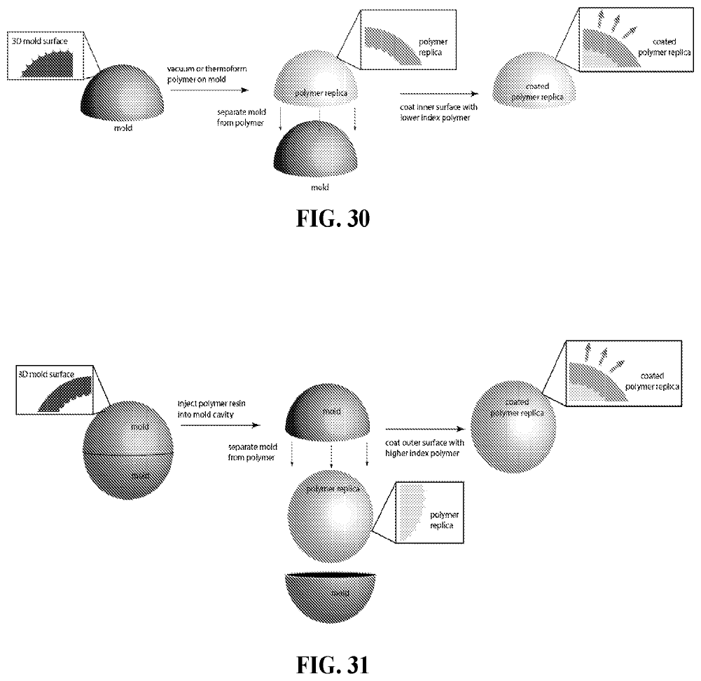

Also provided are methods of forming substrates that exhibit an interference pattern upon reflection of incident electromagnetic radiation on three-dimensional molds. Such methods are illustrated, for example, in FIGS. 30 and 31. As shown in FIG. 30, thermoforming and injection molding processes can be used to produce non-planar two dimensional or three-dimensional parts containing microstructured interfaces capable of reflective interference. For a thermoforming process, a thermoplastic film is heated above its glass transition temperature and wrapped around a heated metal mold containing a pattern of concave microstructures on its surface. In some cases, a vacuum may be applied between the film and mold to encourage conformation of the film onto the mold surface. The mold may be subsequently cooled below the glass transition temperature to freeze in the imprinted convex microstructures in the surface polymer contacting the mold. After removing the part, a lower index coating applied to microtextured surface of the part may be applied to tune the refractive index contrast at the interface and control the iridescent color resultant from interference upon TIR.

As shown in FIG. 31, in an injection molding process, a metal mold containing convex microstructures on its surface is filled with a heated polymer resin, extruded under high pressures through channels in the mold to fill its volume with polymer. Upon filling, the mold and polymer are cooled, forming a solid polymer part that is then removed from the mold bearing concave microstructures on its surface. The part can then be subsequently coated with a higher refractive index material so that a microstructure interface is formed capable of supporting TIR leading to interference among reflected wavelengths of visible light.

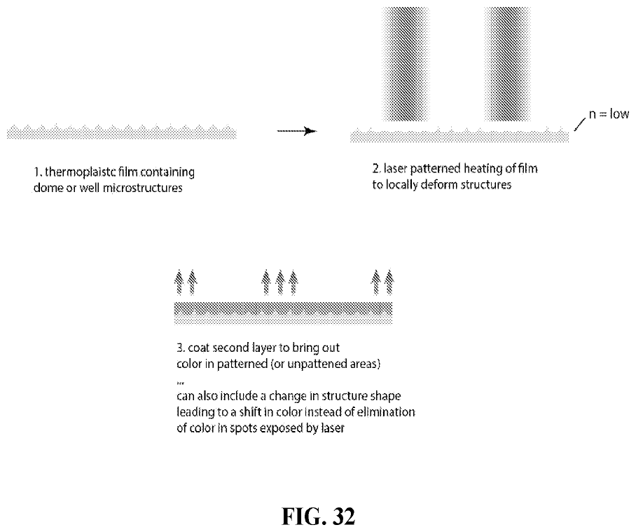

In some embodiments, methods can further involve subsequent modification of substrates following formation of TIR microstructures to alter and/or pattern the TIR microstructures (e.g., to form regions which exhibit an interference pattern upon reflection of incident electromagnetic radiation and regions that do not exhibit an interference pattern upon reflection of incident electromagnetic radiation). These methods can be used to create patterns, logos, and/or text on the substrate. For example, also provided are methods of forming substrates that exhibit an interference pattern upon reflection of incident electromagnetic radiation using a laser direct writing process. Such methods are illustrated, for example, in FIG. 32. As shown in FIG. 32, microstructured substrates composed one or more layers of thermoplastic polymers (e.g., formed using any of the methods described above) can be modified using a laser direct write process whereby absorbed optical energy is transduced into local heating resulting in plastic deformation of the thermoplastic polymer at temperature above the glass transition threshold. Modification of microstructure shape due to laser induced heating may result in a shift in the interference pattern caused by TIR reflected light or a loss of reflected color within a particular region. Absorption of the laser beam can be be manipulated by controlling, for example, aspects of the laser irradiation (e.g., laser position, power, and/or focus), characteristics of the substrate (e.g., thickness of the materials forming the TIR microstructures, identity of the materials forming the TIR microstructures), the composition of coating materials, the incorporation of additives (e.g., pigment additives capable of absorbing or reflecting specific wavelengths of electromagnetic radiation), or any combination thereof. Laser writing onto the thermoplastic polymer layer man be done with or without the presence of other coating layers which may be subsequently added afterwards. The thermoplastic polymer layer can comprise either the low refractive index (concave structures) or high refractive index layer (convex) paired with a second coating layer of an appropriately matching index contrast.

This approach has been demonstrated using a thermoplastic film of glycol-modified polyethylene terephthalate (PETG) ( 1/32″ thick) containing an array of thermoformed concave cylindrical microstructures with a diameter of 60 μm, a depth of 23 μm, a radius of curvature of 31 μm and a spacing of 75 μm. A desktop laser cutter (Full Spectrum Laser, H-series) equipped with a 10.6 μm CO₂ laser beam, was used to illuminate the surface with the structure side facing the beam source. Variation of the beam power between 0.08 to 40 W and scanning speeds between 0.5 and 30 cm/s in vector cut mode was used to modulate the level the thermal exposure to the PETG film. At conditions below 0.08 W power at 100 cm/s scan speed, no change in reflected appearance was observed from exposed regions of the film even after multiple passes. Between 0.08 and 0.4 W power at 30 cm/s scan speed, shifts the reflected color from the exposed regions were observed. Increasing above 0.4 W power and/or at slower scan speeds, resulted in complete cancellation of color from the exposed regions. In this way, the surface could be patterned.

In some embodiments, methods can further comprise micronizing the substrate (formed by any of the methods described above) to form particulates or flakes that exhibit an interference pattern upon reflection of incident electromagnetic radiation. Once formed, the particulates or flakes can be applied as a coating (either alone as a power or in combination with a suitable carrier). Particulates and flakes can be formed using a variety of suitable size reducing techniques, including cutting, ball milling, bead milling, small media milling, agitator ball milling, planetary milling, horizontal ball milling, pebble milling, pulverizing, hammering, dry grinding, wet grinding, jet milling, or other types of milling, applied singly or in any combination. Suitable methods can be selected in view of the materials used to form the substrate (e.g., the first material and/or the second material) and the desired particle size of the particulates or flakes. In some embodiments, the substrate can be treated (e.g., by cooling the substrate) prior to or while micronizing the substrate to improve fracture of the substrate and/or minimize damage to the microstructures during micronization.

In some embodiments, the substrate can be placed in a carrier and/or coating with a material following micronization. The carrier and/or coating can have similar optical properties to either the first material or the second material so as to minimize imperfections resulting from damage to the first material or the second material during the micronization process.

In some embodiments, the largest average cross-sectional dimension of the particulates or flakes can be less than about 500 microns (e.g., less than about 450 microns, less than about 400 microns, less than about 350 microns, less than about 300 microns, less than about 250 microns, less than about 200 microns, less than about 150 microns, less than about 100 microns, less than about 50 microns, less than about 25 microns, less than about 10 microns, or less than about 5 microns). In some embodiments, the largest average cross-sectional dimension of the particulates or flakes can be at least about 2 microns (e.g., at least about 5 microns, at least about 10 microns, at least about 25 microns, at least about 50 microns, at least about 100 microns, at least about 150 microns, at least about 200 microns, at least about 250 microns, at least about 300 microns, at least about 350 microns, at least about 400 microns, or at least about 450 microns).

The largest average cross-sectional dimension of the particulates or flakes can range from any of the minimum values described above to any of the maximum values described above. For example, in some embodiments, the largest average cross-sectional dimension of the particulates or flakes can range from about 2 microns to about 500 microns (e.g., from about 2 microns to about 100 microns).

In some embodiments, the particulates or flakes have an aspect ratio (defined as a ratio of the largest average cross-sectional dimension of the particulates or flakes to the smallest average cross-sectional dimension of the particulates of flakes) of at least 2:1 (e.g., at least 5:1, at least 10:1, at least 25:1, at least 50:1, at least 100:1, at least 250:1, at least 500:1, at least 1000:1, at least 5000:1, at least 10000:1, at least 50000:1, or more). In some embodiments, the particulates or flakes have an aspect ratio of 100000:1 or less (e.g., 50000:1 or less, 10000:1 or less, 5000:1 or less, 1000:1 or less, 500:1 or less, 250:1 or less, 100:1 or less, 50:1 or less, 25:1 or less, 10:1 or less, or 5:1 or less).

The particulates or flakes can have an aspect ratio ranging from any of the minimum values described above to any of the maximum values described above. For example, in some embodiments, the particulates or flakes can have an aspect ratio of from 2:1 to 100000:1 (e.g., from 2:1 to 1000:1, or from 2:1 to 1000:1).

In some embodiments, methods can further comprise applying an adhesive to the substrate. The adhesive can be used to adhere the substrate to an article as described below.

Articles and Methods of Use

The substrates described herein provided in a variety of forms, depending on the intended application for the system. In certain embodiments, the substrates can be formed on an article or packaging for the article, for example, by embossing, casting, molding, or stamping an array of TIR microstructures on the article or packaging for the article. In certain embodiments, the substrate can be fabricated, for example, in the form of a thin film or metallic foil) that can be applied to an article or packaging for the article (e.g., using an adhesive). The precise methods whereby the substrates are formed can be selected in view of a number of factors, including the nature of the materials from or within which the substrate is formed, and overall production considerations (e.g., such that the method readily integrates into the manufacture of an article).

The substrates can be employed to provide authentication of articles (e.g., as a security and anti-counterfeiting feature to identify and distinguish authentic products from counterfeit products) and/or to provide visual enhancement of manufactured articles and packaging.

The substrates can be employed in many fields of use and applications. Examples include:

Government and defense applications—whether Federal, State or Foreign (such as Passports, ID Cards, Driver's Licenses, Visas, Birth Certificates, Vital Records, Voter Registration Cards, Voting Ballots, Social Security Cards, Bonds, Food Stamps, Postage Stamps, and Tax Stamps);

currency—whether Federal, State or Foreign (such as security threads in paper currency, features in polymer currency, and features on paper currency);

documents (such as Titles, Deeds, Licenses, Diplomas, and Certificates);

financial and negotiable instruments (such as Certified Bank Checks, Corporate Checks, Personal Checks, Bank Vouchers, Stock Certificates, Travelers' Checks, Money Orders, Credit cards, Debit cards, ATM cards, Affinity cards, Prepaid Phone cards, and Gift Cards);

confidential information (such as Movie Scripts, Legal Documents, Intellectual Property, Medical Records/Hospital Records, Prescription Forms/Pads, and “Secret Recipes”);

product and brand protection, including Fabric & Home Care (such as Laundry Detergents, fabric conditioners, dish care, household cleaners, surface coatings, fabric refreshers, bleach, and care for special fabrics);

beauty care (such as Hair care, hair color, skin care & cleansing, cosmetics, fragrances, antiperspirants & deodorants, feminine protection pads, tampons and pantiliners);

baby and family care (such as Baby diapers, baby and toddler wipes, baby bibs, baby change & bed mats, paper towels, toilet tissue, and facial tissue);

health care (such as Oral care, pet health and nutrition, prescription pharmaceuticals, over-the counter pharmaceuticals, drug delivery and personal health care, prescription vitamins and sports and nutritional supplements; prescription and non-prescription eyewear; Medical devices and equipment sold to Hospitals, Medical Professionals, and Wholesale Medical Distributors (e.g., bandages, equipment, implantable devices, surgical supplies);

food and beverage packaging;

dry goods packaging;

electronic equipment, parts & components;

apparel and footwear, including sportswear clothing, footwear, licensed and non-licensed upscale, sports and luxury apparel items, fabric;

biotech pharmaceuticals;

aerospace components and parts;

automotive components and parts;

sporting goods;

tobacco Products;

software;

compact disks, DVDs, and Blu-Ray discs;

explosives;

novelty items (such as gift wrap and ribbon)

books and magazines;

school products and office supplies;

business cards;

shipping documentation and packaging;

notebook covers;

book covers;

book marks;

event and transportation tickets;

gambling and gaming applications (such as Lottery tickets, game cards, casino chips and items for use at or with casinos, raffle and sweepstakes);

home furnishing (such as towels, linens, and furniture);

flooring and wallcoverings;

jewelry & watches;

handbags;

art, collectibles and memorabilia;

toys;

food (e.g., on the surface candies including chocolate);

displays (such as Point of Purchase and Merchandising displays); and

product marking and labeling (such as labels, hangtags, tags, threads, tear strips, over-wraps, securing a tamperproof image applied to a branded product or document for authentication or enhancement, as camouflage, and as asset tracking).

In certain embodiments, the substrates systems can be employed on a document or packaging for a document. The document can be, for example, a banknote, a check, a money order, a passport, a visa, a vital record (e.g., a birth certificate), an identification card, a credit card, an atm card, a license, a tax stamp, a postage stamp, a lottery ticket, a deed, a title, a certificate, or a legal document. In some embodiments, the substrates can be employed to provide visual enhancement of an article, such as coinage, CDs, DVDs, or Blu-Ray Discs, or packaging, such as aluminum cans, bottles (e.g., glass or plastic bottles), plastic film, or foil wrappers.

In some embodiments, particulates or flakes of the substrate can form a coating composition which can be applied to articles. In some embodiments, the particulates or flakes of the substrate can be dispersed colloidally in a carrier to form an ink or paint. Such compositions can be applied uniformly over a surface, or in a pattern to aesthetically enhance an article and/or to provide for a method of authentication.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1. Tunable and Responsive Structural Color from Polymeric Microstructured Surfaces Enabled by Interference of Totally Internally Reflected Light

Unlike the color generated from dyes and pigments due to optical absorption, structural colors can be created by optical interference occurring when light interacts with physical structures within or on the surface of a material. Recently, it has been reported that structural coloration is produced when light undergoes multiple total internal reflections (TIR) at concave microscale interfaces; light rays propagating by different trajectories of TIR along an interface experience varying optical path lengths and a subsequent phase shift that leads to interference and structural colors. Unlike well-known nanoscale periodic materials that generate structural color, such as photonic crystals, thin film multilayers, or diffraction gratings, interference from TIR is due to light interacting with microstructures that have dimensions orders of magnitude larger than the wavelength of visible light. The fundamentally different geometric requirements provide opportunities for controlling structural colors in materials and via processing methods where it previously would not have been possible, such as in liquid droplets as previously reported. Described here is a simple route to fabrication of polymeric microwell and microdome-array surfaces that display structural color via TIR interference and characterize how the structural colors are affected by parameters such as refractive index contrast and microstructure geometry. By assembling commercially available monodisperse glass microparticles at monomer oil-water interfaces and polymerizing the monomer, microdome arrays of controllable contact angle and radius of curvature over centimeter scale areas are created. The microstructured surfaces can be replicated via soft lithography into a range of polymeric materials of varying refractive indices and mechanical properties as a means to tune the structural color and responsivity. The iridescent spectral characteristics of the microdome and microwell arrays are examined in detail as a function of diameter, contact angle, and refractive indices. Tunable color is also demonstrated in response to stimuli such as temperature and mechanical deformation. The ability to readily harness the TIR interference optical mechanism in polymeric solid films and elastomers may provide accessible routes for utilizing dynamic structural coloration in stimuli responsive materials, displays, coatings, or sensors.

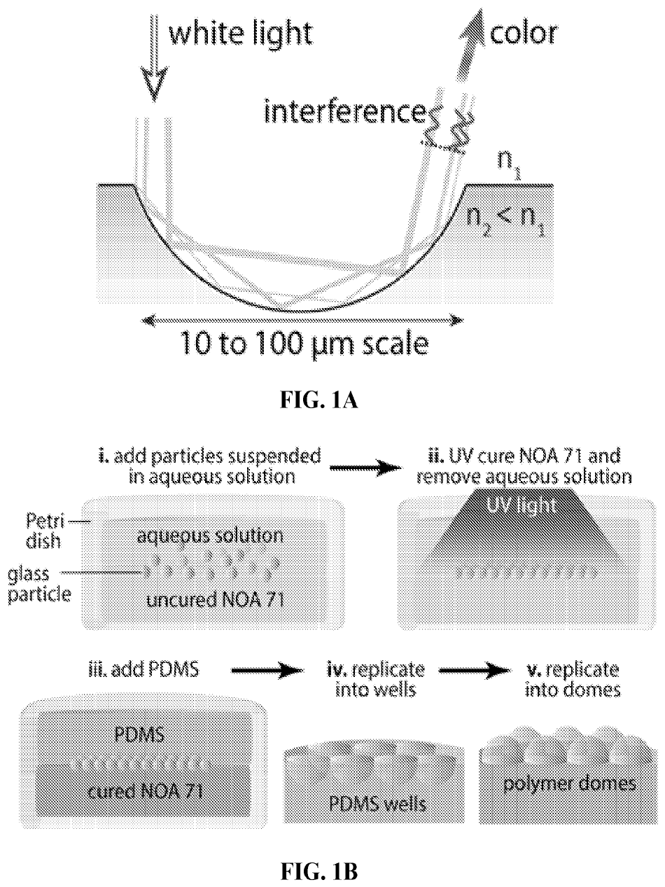

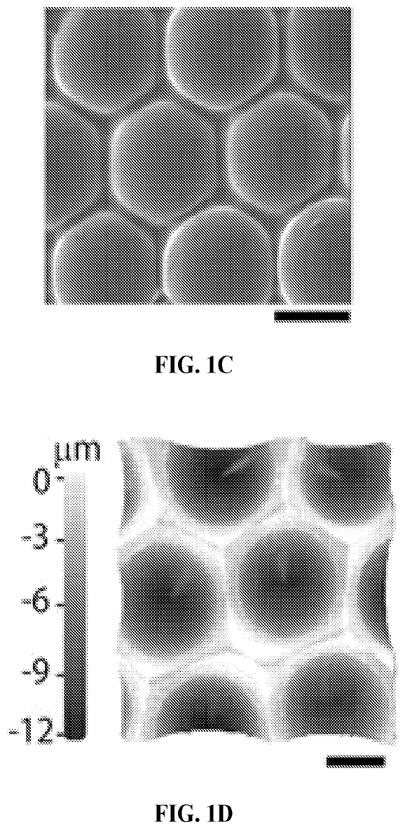

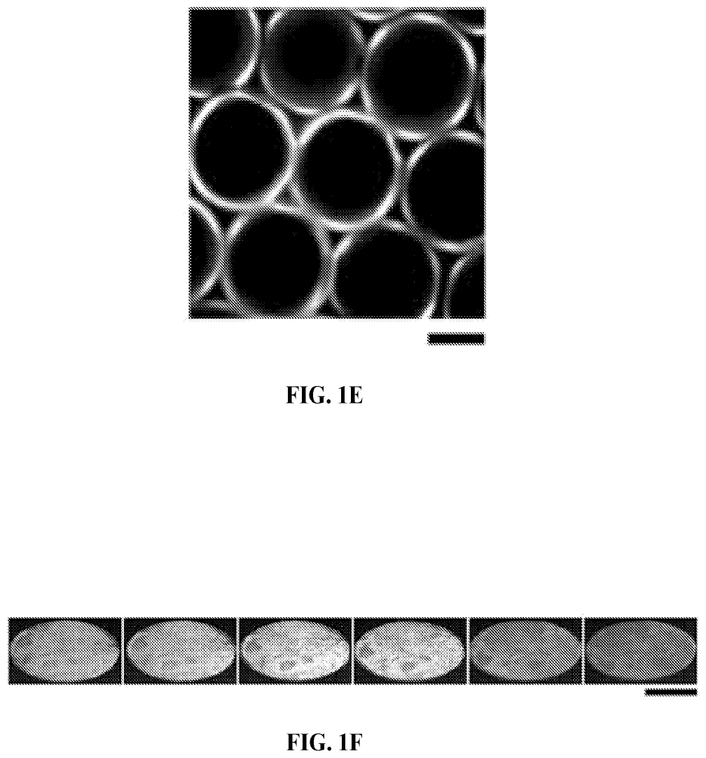

In order to create surfaces with microscale hemispherical structures that support multiple trajectories of TIR to generate interference (FIG. 1A), it was anticipated that a simple approach for large-area patterning could be partially embedding monodisperse spherical particles at a uniform depth within a polymer film. The fabrication method is outlined in FIG. 1B. In brief, a thin layer of uncured Norland Optical Adhesive 71 (NOA 71) was poured into a Petri dish followed by an aqueous suspension of soda lime glass particles (40-43 μm diameter with 95% of particles in range, 0.01 g/mL) in 1 mM hexadecyltrimethylammonium bromide (CTAB) aqueous surfactant. The CTAB is necessary to render the particles sufficiently hydrophobic to be wetted by the NOA 71 and partially sink into the oil-water interface. Ultraviolet (UV) light exposure was used to cure the NOA 71 and fix the particles in place. The aqueous phase was then washed away, leaving behind an array of glass spheres partially embedded in polymer. An inverse replica of this domed surface was fabricated in crosslinked polydimethylsiloxane elastomer (PDMS) to form a uniform array of wells (FIGS. 1C and 1D). The PDMS wells could be subsequently used as a mold to fabricate polymer domes of numerous materials, such as UV-curable polymers, via soft lithography. Domes replicated in epoxy OG142-87 (n=1.51) when viewed in air (n=1) appear white in reflection. The air backing creates a large refractive index contrast resulting in many trajectories of TIR which do not all interfere constructively resulting in muter colors; increased refractive index contrast also results in a larger amount of background reflection which further washes out the colors resulting in a white appearance. However, when the surface is submerged in heptane (n=1.39), bright structural coloration is observed (FIGS. 1E and 1F).

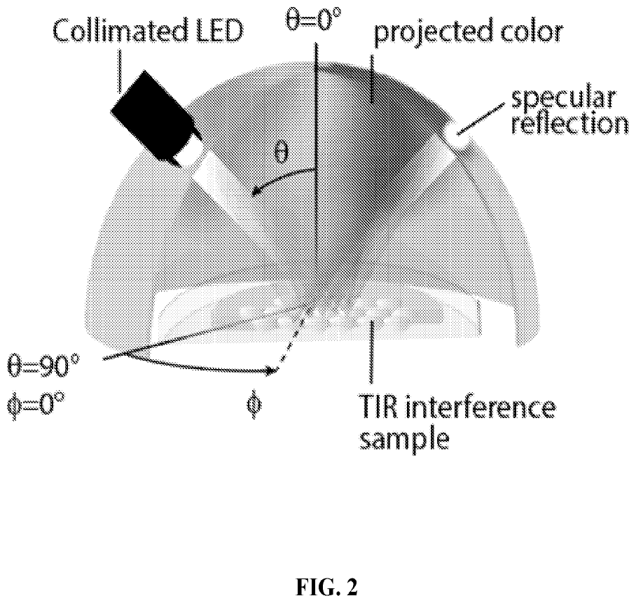

Because these iridescent surfaces display different colors as a function of viewing and illumination angle, a method is required to “map” the iridescence in three dimensions in order to characterize and compare the optical properties of the surfaces. A previously reported method was used in which the sample's reflected light is “projected” onto the inside of a translucent hemispherical screen (which is a half of a ping-pong ball), providing correlation of the colors with specific reflection directions in spherical coordinates (FIG. 2A) Qualitative comparison of an experimentally collected color distribution from the sample shown in FIGS. 1E and 1F with a simulated color distribution for the same geometry, refractive indices, and illumination angle yielded a close match. A spectrometer was used to collect a reflection spectrum for several specific reflection angles and found that the spectra also matched well with those predicted by the interference optical model. Thus, this fabrication method appears suitable for the formation of microwell or microdome arrays that, upon interfacing with an appropriately high or low refractive index material respectively, can generate bright iridescent color from TIR interference.

Having developed a straightforward method to fabricate polymer surfaces displaying TIR interference, it was next aimed to investigate whether control the structural color through variations in geometrical parameters and refractive index contrast was possible. Based on the mechanism of TIR interference, the structural colors were expected to be dependent on the contact angle and radius of curvature of the concave optical interface. For a given glass microparticle used during surface fabrication, the contact angle, θ_{CA}, of the resultant dome is dependent on the contact angle of the microparticle at the monomer oil-water interface (e.g., how far the particle sinks into the monomer oil). Particles that are more deeply embedded into the monomer would thus result in domes with a lower effective contact angle (and hence, shallower wells upon replication in PDMS, following the procedure in FIG. 1B). It was found that by varying the concentration of isopropyl alcohol in the aqueous CTAB solution, it is possible to tune the interfacial tension and manipulate how far the glass particles penetrated into the oil layer for θ_{CA} values ranging from 76.0±5.7° to 93.2±5.1° (average and standard deviation determined by optical profilometry, sample sizes of at least 14 structures). In order to lower the contact angle further, PDMS oil of varying viscosity was used in place of the aqueous CTAB surfactant solution during surface fabrication. Use of PDMS oil with viscosity of 10 cSt resulted in a contact angle of 75.4±1.8°, close to that produced with an aqueous phase with 20 wt % isopropanol solution; when 1 cSt viscosity PDMS oil was instead used, much lower contact angles of 52.3±2.6° were generated. Particles that were embedded in the monomer layer at a contact angle much higher than θ_{CA}=90° could not be easily replicated by PDMS molding and thus were not considered here.

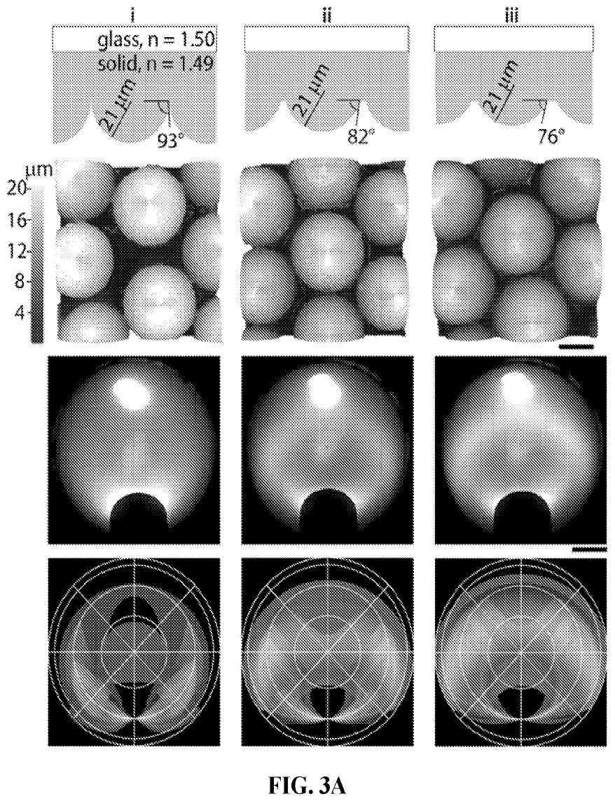

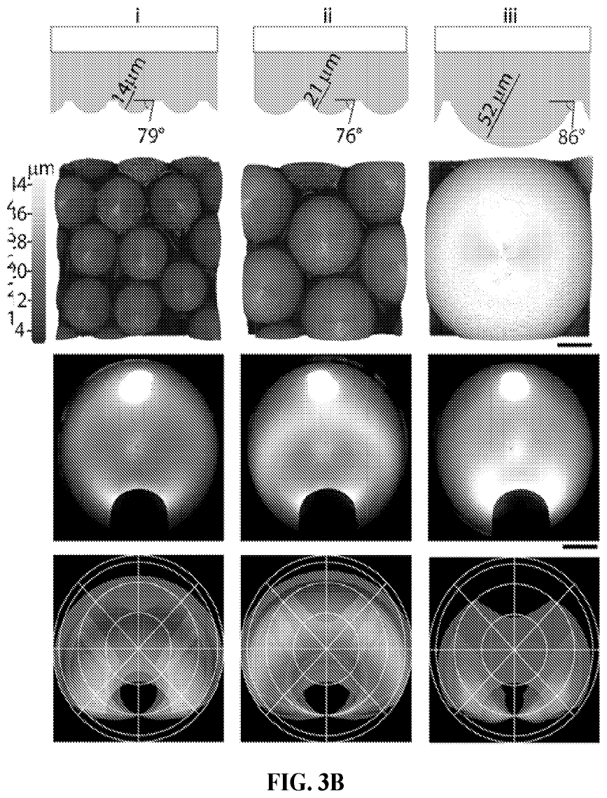

Domes with contact angles ranging from ≈76° to 93° made of a UV-curable epoxy OG 142-87 (n=1.51) were submerged in water (n=1.33) and their color distributions were collected at an illumination angle of (θ=45°, φ=0°) (FIG. 3A). The contact angle of the dome or well determined which light trajectories were allowed for a given input and output angle combination; as the contact angle increased from 76° to 93°, the total number of light rays that were able to undergo TIR upon impinging at the concave interface was reduced for the given illumination angle, and hence the number of possible trajectories of TIR was also reduced. As a result, more vibrant and distinct colors were seen in FIG. 3A, panel iii (lower contact angle) as compared to FIG. 3A, panel i (higher contact angle). The experimental color distributions matched well with the calculated color distributions (FIG. 3A).

The radius of curvature, r, is also expected to influence the structural color as it impacts the optical path length for light undergoing TIR. Radius of curvature is most easily manipulated by starting with glass particles of a different diameter upon initial surface fabrication. Surfaces generated from three diameters of particles (29-32 μm, 40-43 μm and 98-102 μm, 95% of particles falling in range) were examined. Resultant PDMS wells (and subsequent replicated domes) had average r with standard deviation of 14.1±1.2 20.7±1.4 μm and 52.1±3.2 μm, respectively, as determined by optical profilometry for sample sizes of 83 for 14.1±1.2 μm, 45 for 20.7±1.4 μm and 10 for 52.1±3.2 μm (FIG. 3B). Structural color distributions from domes fabricated in epoxy OG 142-87 (n=1.51) and submerged in water (n=1.33) of the three differently sized domes are shown in FIG. 3B and compared well with the colors predicted by the optical model. For a constant refractive index contrast, the dome array with the smallest r had the largest angular separation of the colors, while larger values of r generated bands of color that were narrower and more closely spaced. In essence, for domes with smaller radii, each ray trajectory is shorter and the optical path length difference between interfering paths is smaller, resulting in less pronounced spectral shifts as a function of viewing angle.

Having developed a method to fabricate the structurally colored surfaces in elastomeric solids, it was explored whether mechanical deformation could be used to actuate the colors and examine the effect of an anisotropic structure on the resultant iridescence. PDMS wells (n=1.42, r=20.7±1.4 θ_{CA}=76±5.0°) were created filled with a higher refractive index silicone, Dowsil VE-6001 (n=1.53) to produce a fully solidified elastomeric sample. Stretching of the elastomer wells by even 10 or 15% resulted in significant mechanically-induced shifts in structural color (FIGS. 4A, 4B, and 4C). To create surfaces with an array of permanent ellipsoidal structures, PDMS wells were filled with UV curable epoxy OG 142-87 (n=1.51), which was polymerized while strain in the PDMS was maintained at 15%. The anisotropic ellipsoidal domes, along with precursor spherical domes of the same material, were then submerged in water (n=1.33) and color distribution maps were collected at illumination angles of (θ=0°, φ=0°) and (θ=50°, φ=0°) for ellipsoidal major axis orientations along φ=0° and 90° (FIGS. 4C and 4D). Under illumination at (θ=0°, φ=0°) the spherical domes generated a circularly symmetric color distribution with a singular ring of color, largely red, centered around the light source (FIG. 4C). In comparison, ellipsoidal structures under the same illumination had a distinctly different color distribution, where the red nearly entirely disappeared and was replaced by a light blue and green oval pattern with the long axis of the oval being perpendicular to the long axis of the ellipsoidal domes (FIG. 4C). The elliptical domes imaged with an oblique light angle (θ=50°, φ=0°) similarly yielded a “stretched” version of the color distribution pattern as compared to the spherical domes (FIG. 4D). Hence, the surfaces' colors can be varied by mechanical deformation of an elastomeric surface or rotation of ellipsoidal structures, changing not only the positions of colors, but in some cases actually generating new colors previously not visible under the given illumination conditions.

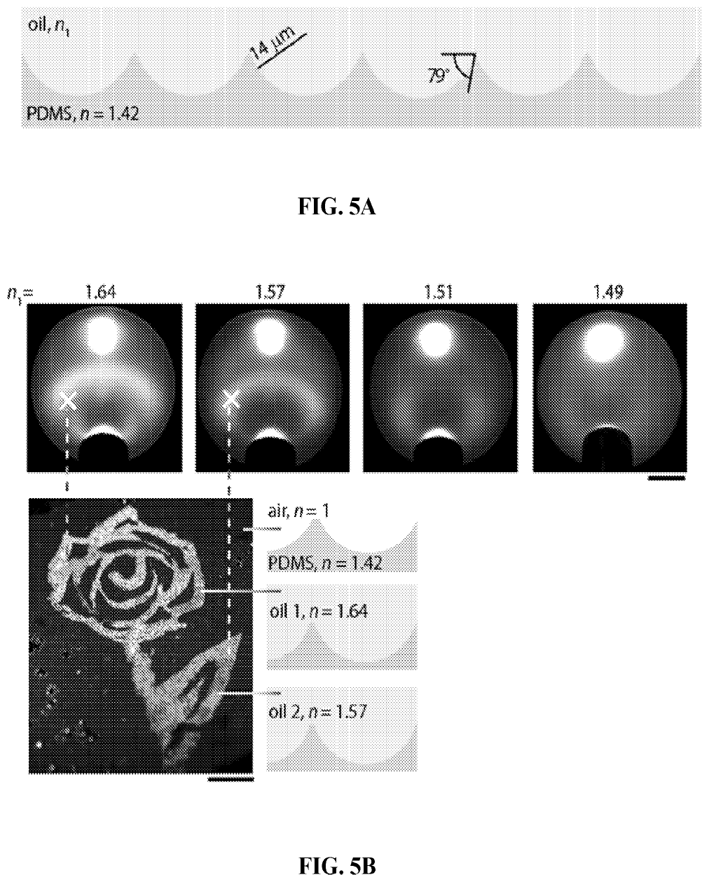

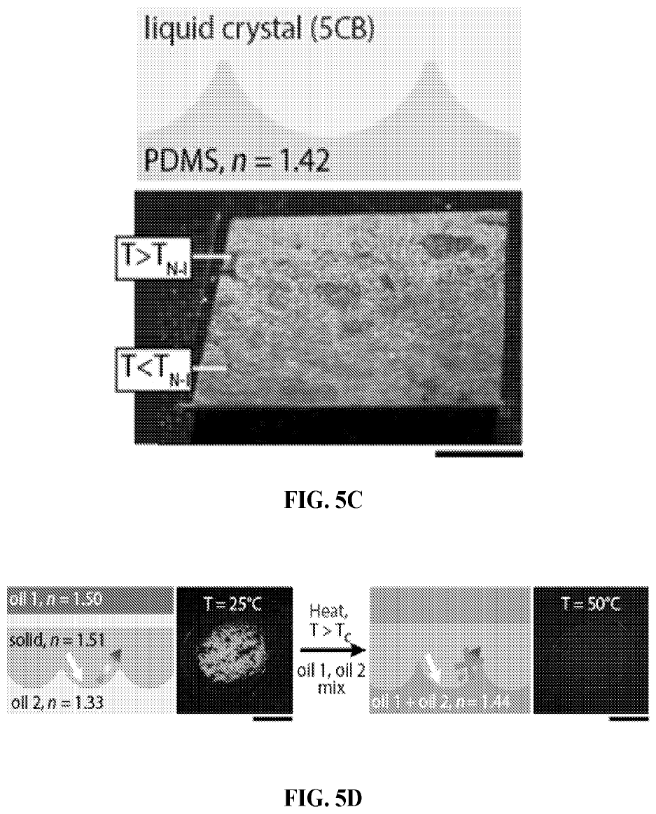

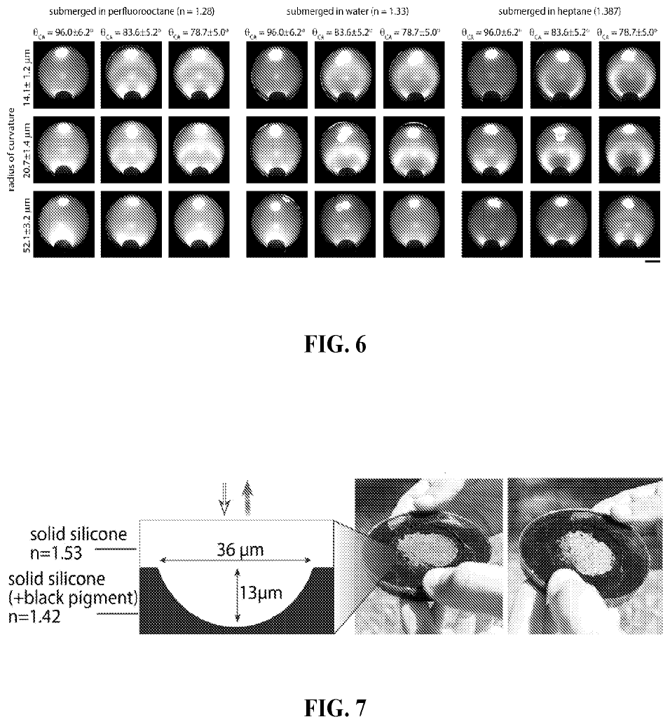

In addition to geometric effects influencing structural color from TIR, refractive index contrast was also expected to impact the reflected color distribution, because the critical angle for TIR, θ_{c}, is directly related to the refractive indices at the optical interface, where θ_{c}=arcsin (n₂/n₁). As the refractive index contrast increases, the critical angle decreases, and more paths of TIR become available. To examine the effect of the refractive index contrast on the structural color, the PDMS wells (n₂=1.42) were filled with liquids of varying refractive index, where the refractive index was tuned through mixing of tetrabromoethane (n₁=1.64), benzyl benzoate (n₁=1.57) and n-decane (n₁=1.41). The color distributions were collected at an illumination angle of (θ=50°, φ=0°) for several refractive index contrasts (FIG. 5A). At too low of an index contrast, (e.g. n₁=1.49) in FIG. 5A), an insignificant fraction of light undergoes TIR and no reflected colors were observed. As the refractive index contrast increased (FIG. 5A), more paths of TIR became available, leading to interference and causing bands of color to appear. Use of increasingly higher refractive index oils affects the perceived color in multiple ways. Besides increasing the refractive index contrast, and thus increasing the total amount of light undergoing TIR, increasing n₁ also refracts the illuminating light rays to a greater degree such that the illuminating rays have progressively lower local incident angles upon striking the concave microscale interface; this refraction not only contributes to increased availability of TIR paths but will also produce a slight shift in the position of the color bands. Increasing n₁ also increases the optical path length of each of the light trajectories; this has an effect similar to increasing the size of the dome and is due to the fact that the optical path length is the product of physical path length and the refractive index. If n₁ was increased while holding the refractive index contrast constant (i.e., n₂ increased proportionally) then the same change in color would be expected as occurs when changing only the radius of the microstructures (again, proportionally). The magnitude of refractive index contrast (n₁/n₂) also determines the amount of phase change occurring upon each reflection and so also affects the colors that are observed. Higher index contrast additionally leads to an overall increase in the intensity of the reflected light; however, if too high of a refractive index contrast is used, the surface appears more white as a result of the many possible trajectories of TIR which do not all interfere constructively and generate muter colors. While the experiments shown in FIG. 5A only examine the effect of refractive index n₁ for one specific radius of curvature and contact angle, additional combinations of geometries and index contrasts achieved by varying n₂ are shown in FIG. 6. In summary, changing the refractive index contrast allows tuning of the intensity and direction of the reflected colors due to variations in refraction and changes to TIR trajectories and path length differences that cause the interference.

The variation in color as a function of refractive index contrast was used to construct an iridescent multi-colored image by “painting” the PDMS wells with different refractive index oils, benzyl benzoate (n=1.57) and tetrabromoethane (n=1.64) (FIG. 5B). Glass capillary tubes loaded with each oil were touched to the PDMS wells to selectively fill specific wells with the oil. Wells filled with high index oils generated TIR interference, whereas the empty wells appeared black as they do not have the appropriate index contrast for TIR (FIG. 5B). When illuminated at an angle of (θ=50°, φ=0°) and viewed at (θ=30°, φ=40°), the wells filled with the higher index tetrabromoethane appeared a pastel pink while the wells filled with benzyl benzoate gave a vibrant green color, yielding a picture of a rose. These colors correlated, as expected, to the angular positions in the color distribution maps for those index contrasts (FIGS. 5A and 5B). It was also also explored whether dynamic changes in refractive index contrast could be used to responsively change the reflected color. Liquid crystals experience abrupt changes in birefringence, and hence refractive index, when undergoing transitions between ordered and disordered phases (Singh, S. & Dunmur, D. A. Liquid crystals: fundamentals. (World Scientific, 2002)). Curious as to how birefringent liquid crystals would influence interference from TIR, PDMS microwells (n=1.42, r=20.7±1.4 μM, θ_{CA}=76.0±5.7°) were filled with 4-cyano-4′-pentylbiphenyl (5CB) liquid crystal. At room temperature, 5CB has a nematic structure with vertical molecular alignment on PDMS and refractive indices for the extraordinary and ordinary ray (nₑ≈1.72, nₒ≈1.53) that are high enough, in principle, to produce color through TIR when paired with PDMS wells (n=1.42). However, the generated birefringence influenced the TIR interference mechanism and resulted in a dull polarization dependent pinkish reflection. As the sample was heated above the nematic-to-isotropic phase transition temperature (T_{N-I}=35° C.), the liquid crystal transitioned into an isotropic state with n=1.59 and vibrant iridescent colors due to TIR interference became visible (FIG. 5C). This temperature-induced color change transition was fully reversible. The reflected color could also be thermally switched on and off by backing domes with two immiscible oils that, upon heating above a critical temperature, mix to form a solution that has too low of an index contrast for TIR. This approach is shown in FIG. 5D with domes of NOA 71 (n=1.56) submerged in a low index fluorinated oil, 2-(trifluoromethyl) ethoxydodecafluorohexane (n=1.28), with a higher index hydrocarbon oil mixture (benzyl benzoate and toluene in a 1:5 volume ratio, n=1.50) floating on top. The index contrast between the domes and fluorinated oil supports TIR to give an iridescent color, but as the solution was heated above the oils' critical solution temperature (T_{C}<T=50° C.) all oils became miscible, raising the refractive index of the mixture to n=1.44. As shown in FIG. 5D, this index contrast was too low to generate TIR interference, and hence the color disappeared. This mechanism was also fully reversible, and upon cooling below T_{C}, the color reappeared.

In summary, a straightforward method is presented to produce and manipulate structural coloration in polymeric surfaces by harnessing interference from total internal reflection in microwells and microdome structures. The approach of embedding glass particles at the interface of water or PDMS oil and UV curable monomer provides a route to both tuning the radius of curvature and contact angle of the resultant hemispherical microstructures, key geometric parameters that affect the structural color. Surfaces fabricated with this method could be easily replicated into other polymers of choice via PDMS molding. The relationship was examined between contact angle, radius of curvature, refractive index contrast, and structure symmetry on the distribution of reflected colors, and the results were compared to those predicted by optical modeling. By dynamically changing such parameters, for example by deforming the surfaces with mechanical force or using temperature to change refractive index, we could create stimuli-responsive color-changing surfaces and create structurally colored patterned images. Many other stimuli-responsive polymeric platforms with similar geometries could be envisioned, such as those that respond to pH, ionic strength, or biomolecules to create colorimetric sensors, for example. Given that long range nanoscale periodicity is not needed, we expect that this fabrication approach and optical mechanism may provide an accessible route to creating and tuning structural colors over larger areas in a greater diversity of materials than is currently accessible, enabling applications ranging from dynamic camouflage to anti-counterfeiting technology.

Materials and Methods

Chemicals and Materials

Hexadecyltrimethylammonium bromide (CTAB) (Fluka, >99.0%), isopropyl alcohol (VWR, >99.8%), Norland Optical Adhesive 71 (Norland), benzyl benzoate (Alfa Aesar, 99+%), n-decane (Alfa Aesar, 99+%), 1,1,2,2-tetrabromoethane (TCI, >98.0%), toluene (VWR, >99.5%), 2-(trifluoromethyl)-3-ethoxydodecafluorohexane (Synquest Laboratories, 99%), perfluorooctane (TMC Industries, >98%), 4-cyano-4′-pentylbiphenyl (Frontier Scientific, 99%), Sylgard 184 polydimethylsiloxane (PDMS) (Dow Corning), Dowsil VE-6001 UV Optical Bonding (Dow Corning), PMS Black Silc Pig pigment (SmoothOn), soda lime glass particles (40-43 μm, 29-32 μm, 98-102 μm diameter, 2.5 g/cc) (Cospheric), OG 142-87 epoxy (Epotek), PDMS oil of 10 cSt and 1 cSt (Gelest).

Microdome and Microw Ell Fabrication Method

Uncured NOA 71 was placed into a thin layer in a petri dish. An aqueous solution of 1 mM CTAB with 0.01 g/mL of dispersed glass particles (40-43 μm, 29-32 μm, or 98-102 μm diameter) was pipetted onto the surface of the uncured NOA 71. The dense particles sank to the water-monomer interface, forming a monolayer. Isopropyl alcohol could be added to the particle solution in varying concentrations (0% v/v, 10% v/v and 20% v/v) to tune the depth the particles settled at the aqueous-monomer interface. The samples were then cured using an OmniCure UV lamp (mercury bulb, 17 W/cm²) for 1 minute, fixing the particles into the cured optical adhesive. The aqueous phase was then removed, and the sample was washed with water and baked at 50° C. for 12 hours to complete the curing of the NOA 71. A variant of this method was achieved with using PDMS oil (either 1 cSt or 10 cSt) instead of the aqueous phase; the procedure was otherwise the same. Dow Corning Sylgard 184 PDMS was then used to create an inverse replica from the soda lime silica particles fixed in the cured NOA 71. The PDMS base and hardener were mixed in a 10:1 mass ratio, mixed, degassed, poured over the polymer sample, and cured in an oven at 50° C. for at least two hours. The cured PDMS was peeled off the fixed particles to yield an array of wells. The PDMS wells could be used directly to create the structural color by filling the wells with a high refractive index oil or polymer, or the wells could be used as a mold to fabricate domes of various polymers, such as epoxy OG 142-87.

Sample Imaging and Characterization

For large area sample illumination, an Amscope LED-50 W light with a collimating lens was used to illuminate the sample. For selected area illumination, a Thorlabs LED light (MWWHF2, 4000 K, 16.3 mW) equipped with a 0200 μm fiber optic cable and collimating lens (CFC-2X-A) was used. The translucent dome used for capturing the iridescent color distribution pattern was created by cutting a 40 mm diameter ping-pong ball in half with a razor blade and drilling a 3 mm diameter hole in the side with a Dremel Model 220. The ping-pong ball dome screen was then placed on top of the well or dome sample and collimated light from the LED was passed through the hole into the center of the sample. All macroscale photographs were taken using a Canon EOS Rebel T6 DSLR camera mounted to an optical table and positioned at specific angles, as indicated in the primary text. Scanning electron micrograph (SEM) images were taken using an FEI Nova NanoSEM 630. Profilometry images were taken using a Zygo NexView 3D Profilometer. Optical microscope brightfield images were taken using a Nikon Eclispe Ti-U inverted microscope and an Image Source DFK 23UX249 color camera.

Effect of Varying Refractive Index Contrast on Color

To test how the refractive index affects the perceived color (FIGS. 5A-5D), PDMS wells replicated from 40-43 μm glass particles embedded in NOA 71 originally in an aqueous phase of 1 mM CTAB and 20 v/v % in isopropyl alcohol were filled with varying concentrations of tetrabromoethane, benzyl benzoate and n-decane to observe the effect of refractive index difference at the concave interface. The refractive indices of the oil mixtures were measured using a J457FC refractometer (Rudolph Research Analytical).

Mechanical Force Experiments

Stretchable films of well arrays were fabricated by removing cured NOA 71 with fixed soda lime silica particles (40-43 μm diameter) at the surface from its 5.5 cm Petri dish and placing it in a larger 8.5 cm Petri dish. PDMS dyed black with Silc pig pigment was then poured over the polymer sample and cured to form an array of microwells that were indented into a 5.5 cm well a couple mm deep. Dowsil VE-6001 was used to fill the 5.5 cm well with the PDMS and cured with an OmniCure UV lamp (mercury bulb, 17 W/cm²) for 2 minutes. Because the Dowsil remains tacky when cured, an additional thin (1 mm) layer of transparent PDMS poured on the surface and cured to form the sample.

Fabricating Ellipsoidal Domes

A sample of glass particles (40-43 μm diameter) embedded in NOA 71 was prepared from an aqueous solution of 1 mM CTAB and 20 v/v % in isopropyl alcohol. PDMS wells were molded from the embedded particles. These wells were stretched using two metal clamps, filled with uncured OG 142-87, and then UV cured for 1 minute at 100% power of an OmniCure UV lamp (mercury bulb, 17 W/cm²). The polymerized domes were then removed from the PDMS mold. The cured polymer was then removed and backed with water to give an index contrast that promotes TIR and iridescent color.

Liquid Crystal Heating

PDMS wells replicated from particles embedded in NOA 71 originally in an aqueous phase of 1 mM CTAB and 20 v/v % in isopropyl alcohol were filled with 5CB liquid crystal in its nematic state at room temperature. The wells were heated to 40° C., above the nematic to isotropic transition temperature, where the liquid crystal loses its birefringence and the resulting color became much more vibrant.

Drawing Structural Color Images in Microwells

PDMS wells replicated from particles (29-32 μm diameter) embedded in NOA 71 fabricated using an aqueous phase of 1 mM CTAB and 20 v/v % in isopropyl alcohol were selectively filled to create an image. 1.05 mm ID, 1.5 mm OD borosilicate square capillary tubes were filled with benzyl benzoate or tetrabromoethane. The capillary was dragged across the surface of the PDMS, filling the wells with the oils to create an image of a rose.

Temperature-Responsive Structural Color Using Phase Separation of Oils

PDMS wells were generated from particles (40-43 μm) embedded in NOA 71 originally deposited from an aqueous phase of 1 mM CTAB and 20 v/v % in isopropyl alcohol. Domes of OG 142-87 (n=1.50) were replicated from the PDMS wells and the surface was placed in 35 mm Petri dish containing fluorinated oil, 2-(trifluoromethyl)-3-ethoxydodecafluorohexane (n=1.33), which gave a refractive index difference that generates coloration from multiple TR. A 5:1 volume mixture of toluene to benzyl benzoate (final refractive index of n=1.50) was placed on top of the fluorinated oil with the dome array. The hydrocarbon oil mixture and the fluorinated oil were used in a 3:1 volume ratio. At room temperature, the toluene and benzyl benzoate solution are immiscible with the fluorinated phase, but once heated to 35° C., all the oils became miscible, raising the refractive index of the mixture to n=1.44. This high refractive index backing of the domes no longer supported TIR to produce structural color. Upon cooling back to room temperature, the fluids phase separated, and color was again visible.

Measuring the Reflection Spectra of the Samples

Experimental spectra were collected with an Ocean Optics Maya2000 pro spectrometer. The sample was placed in a water-filled petri dish on a Thorlabs rotation stage. A collimated optical fiber was mounted at 45 degrees illuminating the sample with an Ocean Optics halogen light source HL-2000. The spectrometer was coupled into another collimated optical fiber also mounted at 45 degrees on the rotation stage such that both the sample and spectrometer rotated together so that the azimuthal angle between the light and collection fibers could be varied as the spectra were collected. A mirror was used as a reference, and the illumination was turned off into order to collect the background signals, which were subtracted from the sample and the reference spectra.

### Example 2. Color-Shifting Coatings from Microstructures Enabling Total Internal Reflection Interference

Coloration significantly influences how we perceive and interact with the world around us. Structural colors created by interference of light are of special interest because they do not fade (unlike dyes) and exhibit iridescence, meaning the colors shift position or hue with illumination or viewing angle. Beyond aesthetic applications of color in self-expression, such as for cosmetics and apparel, structural color and tailored spectral reflectance of coatings are useful for technological, safety/security, and military applications with broad societal impact. Examples include color-shifting holograms on security labels and anti-counterfeiting measures, camouflaging coatings, retroreflective signs and road markings, and laser-guided navigation. Structural colors due to optical interference are most often generated by either diffraction or thin film interference mechanisms, both of which require nanoscale periodicity on scale of the wavelength of visible light (˜300-800 nm) and typically contain interfaces of high-refractive-index-contrast metals and oxides. As such, they are expensive to process (e.g. require vacuum deposition of inorganic films) and may have limited optical customizability (e.g. hue/shade/tint, angular positions and separation of colors, interference pattern) due to restrictions in geometry imposed by nano-manufacturing challenges. The present disclosure is a fundamentally different geometric design and mechanism for creating optical interference and structural color by using interference occurring when light undergoes total internal reflection (TIR) in polymeric structures on the 10 to 100 μm scale (FIG. 1). This disclosure creates value by enabling customization of optical reflectivity and interference through microstructure design in a diversity of materials at reduced processing complexity and cost. Potential users are companies who use the technology in their own manufacturing and formulation to tailor reflective optical properties of their products. The present disclosure can demonstrate proof-of-concept of process scalability in polymer films using hot embossing, fabrication of molds and masters for embossing using additive manufacturing and electroforming, and customization of diverse optical effects including structurally colored images.

Research to Date

Research to date has focused largely on investigating the mechanism for structural coloration generation in microscale liquid droplets. The iridescent coloration was observed in biphasic oil droplets in water and subsequently in wetted water droplets. The coloration was surprising because there were no physical characteristics of these materials that were consistent with known mechanisms of structural coloration: all liquids were clear, there were no nanoparticles, and all the droplets were on the 10 to 100 μm scale. Variables such as droplet radius of curvature, contact angle, and refractive index contrast affected the coloration. Initially motivated by these intriguing observations, it was discovered that the coloration results from light interference occurring due to total internal reflection (TIR) at the microscale concave interface of the droplets. TIR is a common optical phenomenon in which light is completely reflected upon striking an interface with a lower refractive index medium above a critical angle. If that interface is concave, light may reflect multiple times by TIR; light rays taking different paths of TIR, for instance by bouncing different numbers of times at a concave interface, have a different path length and a subsequent phase shift, leading to optical interference when those path length differences are on the order of the wavelength of the light (FIG. 1A). Colors generated by this mechanism have large angular separation, tens of degrees, as easily viewed and characterized in spherical coordinates using a hemispherical dome “projection screen” (i.e., a half a ping-pong ball) (FIG. 2). A model has since been created that accurately reproduces the observed iridescence for spherical interfaces. In summary, to produce this structural coloration effect only requires two key elements: 1) an interface between a high index and lower index material to allow for TIR and 2) a microscale concave geometry to support multiple paths of TIR.

Liquids have excellent properties for tunable optics, including deformability, adjustable refractive index and absorption, and ultra-smooth surfaces with variable curvature. Viable strategies for liquid interface manipulation to fine-tune a fluid optical element and approaches for controlling fluid interfaces within complex multiphase systems are critical for advancement of optofluidics. Understanding light-matter interactions more generally allows probing and control of the chemical, physical, and structural properties of materials. Elucidation of approaches by which light can be directed to interact with matter to generate characteristic spectral signatures, such as interference patterns or color, has significant fundamental and applied impact in fields ranging from optics to surface science and practical applications as diverse as display technologies to sensors and paints. Prior work describes a fundamentally divergent mechanism of creating iridescent color created using micron scale features that extends the strategies by which reflective color can be manipulated in materials.

Existing iridescent or color-shifting coatings and inks rely on well-known strategies for generating structural color, most prominently diffraction and thin film interference. Both mechanisms rely on light interference generated from nanoscale features with high refractive index contrast, such as periodic surface gratings or thin-film multilayers involving metals and oxides, to produce iridescent optical effects. Control over nanoscale architecture typically demands expensive processing conditions, such as high-vacuum chemical or physical vapor deposition and clean room use, driving up the cost and preventing their use in commodity applications. The degree of optical tunability, such as ability to alter the reflected colors and their spectral separation over large angles, is also fundamentally limited by these optical mechanisms. The distinctly different geometric requirements of the proposed mechanism of microscale TIR (μ-TIR) coatings provide opportunities for fabricating, designing, and controlling iridescent coloration in materials and with processing approaches not possible using existing optical interference mechanisms. Microstructures are more easily fabricated by a diverse array of common manufacturing technologies which could allow for simpler, lower cost processing. The tunability of these microstructure geometries (size, depth, curvature, index contrast, number of sides, angles between sides etc.) can be used to generate highly customizable color patterns with wide angular separation and uniquely tailorable optical characteristics. Because of the optical efficiency of TIR, even relatively low refractive index contrasts achievable with polymer interfaces yield intense optical effects, expanding the range of easily-processable and commodity materials that could be utilized in the coatings. This new optical mechanism of μ-TIR invites exciting possibilities for generating color shifting, iridescent materials and surfaces.

A fundamentally new mechanism has been discovered for creation of color shifting/iridescent structural color effects accessible in microstructures. Due to the distinctly different geometric requirements necessary to achieve structural color by this mechanism in comparison to state-of-the-art, tunable structural colors and interference patterns can be accessed in materials and with processing approaches that would never before have been considered. As such, this technology can not only serve to reduce cost, but more importantly expand the customizability of optical effects for a broad range of applications. The fundamental optics of μ-TIR can be harnessed for applications ranging from aesthetic (e.g., makeup) to security (e.g., color shifting inks and anti-counterfeiting labels) to military use (e.g., camouflage, remote sensing). Security coatings are critical for societal protection and anti-counterfeiting measures for products ranging from credit cards, concert tickets, and medicine to our own national currency. Developing methods by which to create distinct, easily recognizable optical effects that are also difficult to reverse engineer or imitate would enhance security. The disclosed coatings not only generate interference leading to color, but also create distinct and tunable interference and scattering patterns for monochromatic laser radiation that could be useful for remote targeting and sensing applications. Optical remote sensing in which reflected light scatter is observed is critical to military operations and identification of targets from a distance. Laser guidance, in which reflected laser scatter is used to gain information about the position of desired target, is used to guide missiles and robots (i.e., referred to by the phrase, “painting the target”).

While prior research has focused largely on optical properties of fluids, the same optical phenomena can be explored in solids, particularly in polymers. By exploiting μ-TIR in polymers, solid form factors useable in a wide range of practical applications can not only be generated, but polygonal and irregular structures that are not accessible in fluids can be explored. To provide evidence for the potential of this fundamental work to be translated to applied research and a commercial product, preliminary work to demonstrate creation and tuning of coloration from μ-TIR in solid, polymeric surfaces has been performed. Using interfacial assembly of monodisperse particles, arrays of hemispherical dome or well structures were created that when interfaced with an appropriately high or low index polymer, generate structural color in solids (FIG. 7). By tuning parameters such as the radius of curvature and contact angle the reflected color can be tuned. Using typical soft lithography methods (i.e., polydimethylsiloxane (PDMS) molding) these microstructure surfaces can be replicated into various materials with desirable properties, such as a specific refractive index or mechanical elasticity.

μ-TIR as a platform technology has relevance to many commercial markets, including: automotive and architectural paints, consumer electronics, apparel, cosmetics, security, micro-optics (see letter from Nanoscribe), and military use. Product form factors necessary for a diversity of markets ranges from films to powders to fluid dispersions. Success in film-based form factors paves the way for dispersions, as the films can be subsequently ground into particles for dispersion into carrier solvents or pressed into powders. To give a sense of market size, the global special effects pigments market is expected to reach USD 969.2 million by 2020 and the security labels market is expected to reach to reach USD 26.47 billion by 2020.

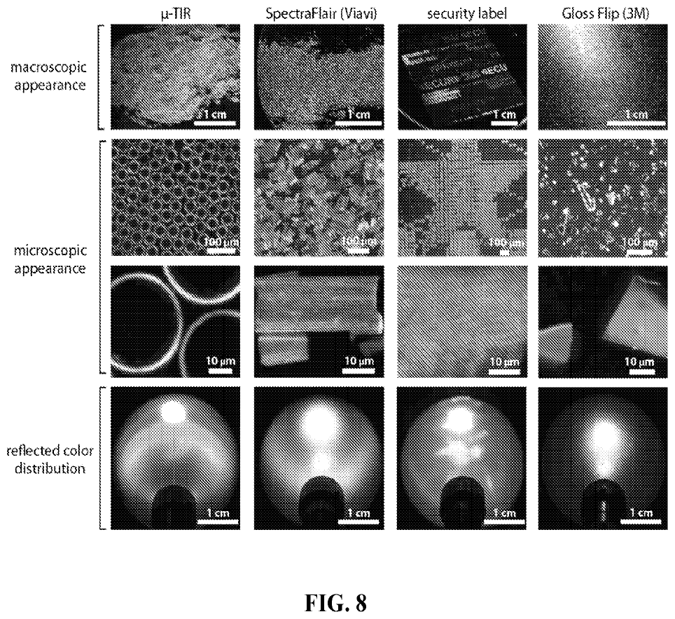

There are a number of companies that manufacture and sell films, powdered pigment, or liquid dispersion products that exhibit iridescent color shifting effects, often described using terms such as “prismatic”, “color-traveling”, “optically variable” or “holographic” (FIG. 8). The applications of these products are diverse, but largely fall into two categories: 1) aesthetic applications, which includes products such as automotive coatings³⁶, cosmetics⁶, and apparel, and 2) security applications for anti-counterfeiting protection⁸ on items such as currency, credit cards, and branded consumer goods. Despite their apparent diversity in form and application, all of these competitor products rely on the same underlying optical principles: thin-film interference, diffraction, or a combination of both.

Pigments and inks. Special-effects pigments can be used in either a powder formulation or dispersed in a fluid for painting applications and are used in products ranging from makeup to plastics, inks, and automotive coatings. Examples of commercial interference and color-shifting pigment products include³⁶: SpectraFlair and ChromaFlair (Viavi), Reflecks (BASF), and Colorstream (Merck). These interference pigments are inorganic-based composed of nanoscale multilayers of reflective metals and transparent oxide or fluoride materials. The layered thin film design can also be modified to have internal or surface diffraction gratings that enhance the amount of color-separation and color diversity. For example, SpectraFlair pigments are composed of a reflective aluminum core sandwiched by magnesium fluoride nanolayers patterned with a nano-ribbed diffraction grating surface and are produced using physical vacuum deposition onto a sacrificial polymer substrate sheet. The inorganic sheets are subsequently broken into flakes of high-aspect-ratio, with thickness under 1 μm and lateral dimensions on the 10-50 μm scale (FIG. 8). ChromaFlair is similar in that it is an inorganic multilayer pigment, but it only utilizes thin film interference to generate optical effects, and hence colors shift between only two shades. Nanoscale precision of each of the layers deposited using physical vapor deposition is required to ensure uniform, reproducible color from interference. Due to the complex multi-step processes requiring high-vacuum deposition during formation, such pigments can retail for dollars per gram, bringing the cost of a gallon of paint to hundreds or thousands of dollars. Despite the premium cost, hundreds of millions of dollars of these special effects pigments are produced and sold each year (see section 2.7 Target Market). Optically variable color-shifting security inks, such as produced by Kao Collins, Authentix, and SICPA are used on products ranging from banknotes to passports and concert tickets. While there are many varieties of optically variable inks (invisible inks, fluorescent inks, etc.), the color-shifting inks are often formulated dispersions of multilayer effects pigments designed with low-viscosities for compatibility with high-speed gravure or flexographic printing processes.

Films. Iridescent or special effects films are used in applications ranging from car wraps to gift wrapping paper to security labels and apparel. Films can be cut into pieces to create glitter. Commodity color-shifting film products, such as in gift-wrap and glitter, is formed from multilayers of organic polymer thin films (often polyethylene terephthalate, PET) that are assembled at scale using co-extrusion. The patterning of diffraction gratings or addition of a thin metallic reflective layer along with traditional chemical dyes can be used to customize the optical effects at the cost of additional materials and process steps. For example, 3M produces a series of color-shifting vinyl films called Gloss Flip (FIG. 8) and Stain Flip, which come backed with adhesive films used to wrap aftermarket automotive vehicles. The polymer film, produced by continuous roll-to-roll fabrication methods, is around 90 microns thick and is embedded with aligned multi-layer interference pigments (FIG. 8). Security label, also known as security holographs, are produced by a range of companies such as Intertronix and Kurz. These labels consist of a layered polymer or metal film embossed with diffraction gratings that produce interference. The gratings are patterned to form an image and can be stacked in multiple layers and precisely offset to produce a kinetic, image-shifting appearance with different colors when viewed from varying angles.

The disclosed μ-TIR technology relies on a fundamentally different optical mechanism than competitors, namely interference occurring when light travels by different paths of TIR. This mechanism allows structural coloration to be generated in concave microstructures with feature sizes on the scale of 10-100 μm, without the need for reflective metal coatings. The TIR technology thus has the following key differentiators: Unique customizable color effects by tuning and patterning of microstructure geometry.

Relatively small changes to the size and shape of microstructures have significant effects on the observed reflected color patterns. Not only spherical interfaces, but also polygonal or irregular structures, can be used to constrain paths of TIR and tune reflected wavelengths of color. By controlling the design of individual microstructures through additive techniques for mold fabrication, we can customize the color-shifting effects to a great degree. Furthermore, by patterning arrays of different geometries of microstructures together on a surface, the creation of structural color images with tailorable color-shifts, which is particularly appealing for anti-counterfeiting applications where a colored symbol, message or logo can be displayed or hidden depending on the viewing angle or lighting conditions across patterned surfaces.

Wide angular separation of colors. For thin-film and diffraction-based iridescent surfaces, the angle of color separation tends to be small (a few degrees) and illumination angular dependence of color is high, such that minute shifts in the viewing or illumination angle results in a full color shift from red to blue. Furthermore, there are a limited set of viewing angles that produce interference such that no color is observed from many perspectives. For coatings using μ-TIR, there is a much wider angle of color separation, on the order of tens of degrees such that a single uniform color is observed over a larger area of a coated surface. Additionally, the disclosed coatings exhibit a much smaller illumination angle dependence of the surface, so that when tilting a coated surface, the observed color is preserved for a much wider range of angles (tens of degrees). These features result in coatings with vibrant color-shifting effects noticeable from a wider range of viewing perspectives and with uniform colors displayed over much larger surface areas.

Scalable fabrication of microstructures via microreplication processing. The ability to produce iridescence and structural coloration from microstructures two to three orders of magnitude larger than the wavelength of visible light and eliminate the need for metal or oxide coatings removes constraints imposed by nanoscale and vacuum processing methods typically utilized in existing iridescent coatings (e.g., nanoscale diffraction gratings and multilayer inorganic thin films). The μ-TIR microstructures can be easily fabricated in polymeric materials, glass, or composites over large areas using imprinting processes such as hot embossing⁵¹ that can be performed in a scalable manner.

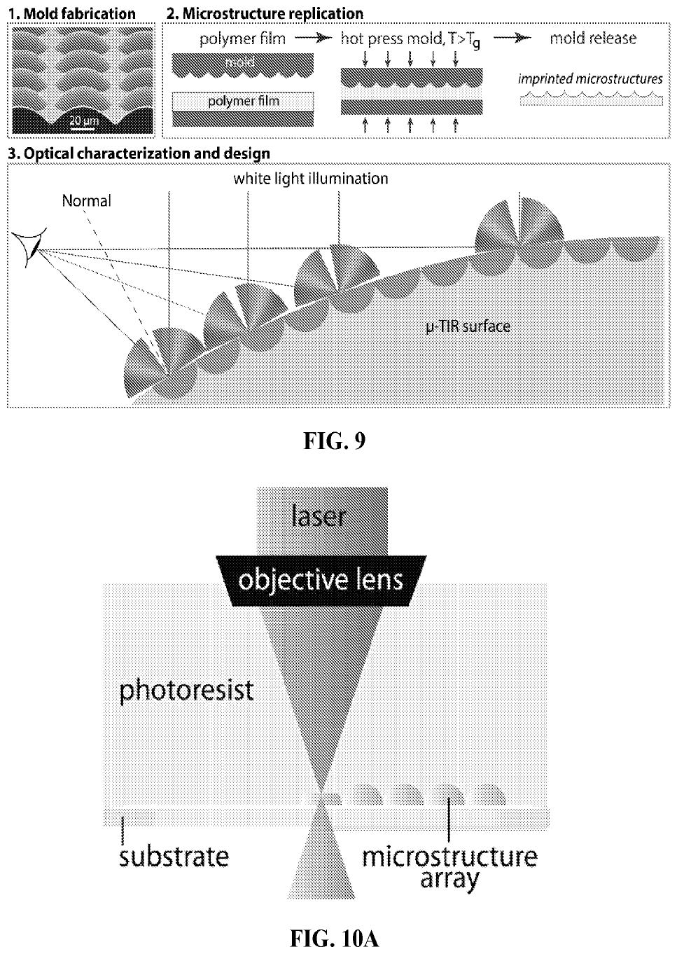

The present disclosure provides a bench-scale process for: 1) generating our own custom polymer microstructure masters and nickel molds; 2) embossing and replicating uniform arrays of microstructures from those molds in layered polymer films over larger areas; 3) characterizing the optical characteristics of such surfaces to gain understanding of the relationship between reflectivity, geometry, and refractive index. The knowledge from (3) can feedback into (1), allowing iteration and customization of design structural color images and patterns to create iridescent surfaces with controllable color-shifting optical effects (FIG. 9).

Mold Fabrication

In order to serially replicate μ-TIR coatings in a scalable fashion by hot embossing, methods by which to fabricate the metal molds to be used for the embossing are developed. The two key milestones thus are: the ability to fabricate custom designs of μ-TIR master structures, and the ability to convert those master structures to nickel molds of high fidelity that are mechanically robust to be used for hot embossing. For microstructure fabrication of the masters, the focus is on using multiphoton lithography, which is a direct-write microscale additive manufacturing method that will enable fabrication of precisely tailored arrays of polymer structures rapidly. Electroforming can then be used to transform the polymer masters into nickel molds to be used for embossing.

Multiphoton Fabrication of Microstructures

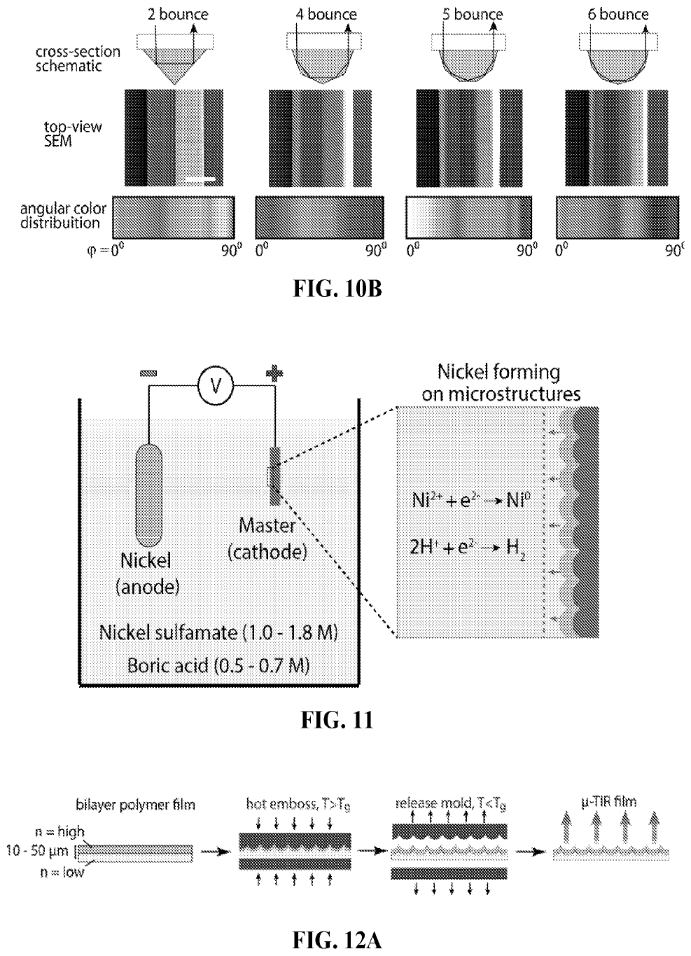

Multiphoton lithography is a laser-based additive fabrication method enabling printing of irregularly shaped and customized microstructures with optically smooth surfaces, ideal for fabricating master structures for μ-TIR (FIG. 10A-10B). This lithography technique creates custom microscale structures using a scanning focused laser that cures liquid photoresist in a programmable pattern using automated software. Nanoscribe's multiphoton lithography tools that automate fabrication of wafer-scale can be used, custom microstructures in polymer resists to create the master μ-TIR structures (FIG. 10A-10B). A GT3D Nanoscribe printer is a representative example of what can be used. For larger areas and longer print times, a Nanoscribe GT2 platform with an upgraded system can be used. This upgraded Nanoscribe GT2 platform is able to stitch patterns using a relatively large field of view (˜2×2 mm) thus enabling a 15 cm² master to be printed in a matter of hours. Nanoscribe continues to innovate in their fabrication tools to enable scalable, laser-based additive manufacturing, such as with the Quantum X platform soon to be released that focuses on rapid printing of 2.5D structure arrays at wafer scales. The variables in the laser processing can be investigated, such as scanning speeds, Z-slice resolution (i.e., step size in depth which affects surface roughness) and resin formulation (which affects the resolution of the curing volume at the laser focus) to optimize the performance for μ-TIR while minimizing print time. The optical properties of the master structures can be investigated directly using reflection optical microscopy, and the “ping-pong ball” technique and can characterize the microstructures' geometry and surface roughness using scanning electron microscopy (SEM) and profilometry.

Converting Masters into Nickel Molds Through Electroforming

The master structures fabricated by multiphoton lithography with the Nanoscribe can be converted to mechanically robust nickel molds (also called shims) suitable for hot embossing. These nickel molds can be by electroforming, in which nickel is electrochemically deposited onto the master to create an inverse replica. Electroforming is a widely used technique for transferring surface patterns into sturdy, metallized replicates up to a millimeter thick. An electroforming system requires a cathode (platinum-sputtered polymer master), anode (nickel) and electrolyte (nickel sulfamate buffered with boric acid, pH˜4) (FIG. 11). Depending on the current density, a conformal nickel layer of 100 μm thick can be deposited in a matter of hours. When complete, the polymeric master can be removed from the nickel mold and subsequently used for embossing. The effect of current density, speed of deposition, nickel thickness, and electrodeposition bath reaction concentrations and conditions can be investigated to assure the highest fidelity and robust mold formation. Mold geometry and surface roughness can be characterized and compared to the master structures by use of SEM and optical profilometry.

Embossing of μ-TIR Films

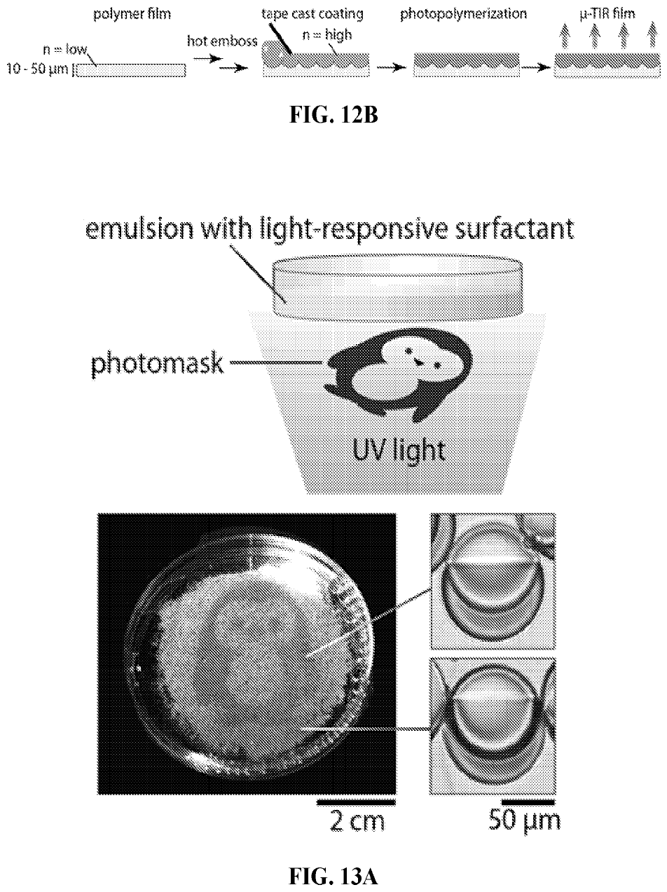

Hot embossing can be used to print and serially replicate custom designed patterns of μ-TIR structures on polymer substrates over large areas, e.g., at least on the scale of 1 cm², 5 cm², 10 cm², 15 cm², 20 cm², 25 cm², or more. In the simplest form, embossing consists of a single step in which a deformable polymer substrate is pressed onto a rigid mold decorated with surface structures which are imprinted onto the polymer (FIGS. 12A-12B). Often, the embossing is conducted at temperatures above the glass transition temperature (T_{g}) of the polymer so that the polymer more easily flows into the mold (i.e. hot embossing) and the structure becomes fixed into the polymer when cooled below T_{g}. Embossing allows scalability for μ-TIR production and enables characterization of optical properties of the surfaces over larger areas.

For initial development of the embossing process itself, commercially available microlens array nickel molds can be purchased. This allows work on the hot embossing development process while concurrently developing the custom masters and molds using multiphoton lithography and electroforming. As per the requirements for μ-TIR, there must be a high-to-low refractive index contrast interface within the concave microstructure with a difference between refractive indices (Δn) of at least ˜0.1 (this value is geometry dependent). Representative polymers to combine with suitable refractive index contrast are given in Table 1. Two approaches to generate this high-to-low refractive index interface are depicted in FIGS. 12A-12B. In the first method (FIG. 12A), a bilayer polymer film with the built-in high-low refractive index interface (e.g., using combinations of thermoplastics shown in Table 1) are embossed together in the same mold to form a concave micro-patterned interface between the two polymers that supports TIR. This film could be used as-is, or encased/coated in another protecting or adhesive layer. Potential downfalls of this approach include poor adhesion between the two film layers, mismatch in thermal coefficients of expansion leading to irregular structures, or mismatch in glass transition temperatures that prevents effective hot embossing. The second method is shown in FIG. 12B. In this two-step process, one polymer is hot embossed with surface structures and the second layer is doctor bladed/tape casted over the surface then cured (e.g. UV photo-cured or thermal-cure) to form the high-to-low refractive index interface. Adjusting the height of the blade with respect to the surface can be used to control the thickness of the deposited coating with a precision below 10 μm. In FIG. 12B, the low-index film being embossed and the high index polymer being casted is shown, but vice versa is also possible. While this second method takes an additional processing step, it has the advantage of more direct and precise control over the optical interface geometry during embossing. Key parameters to be investigated that influence the fidelity of the embossing process include applied stress, strain rate, and mold temperature. Embossed surfaces will be characterized with SEM and optical profilometry (for surface roughness and geometry) and optical reflection microscopy (to visualize the colors reflected by μ-TIR from each surface structure).

TABLE 1
Representative low and high index polymers to be explored/combined
to form concave microstructures capable generating μ-TIR.

| Possible low index polymers | Possible high index polymers |
|---|---|
| Silicones (~1.40) | Polyethylene terephthalate |
| | (1.58-1.63) |
| Poly(methyl methacrylate) (1.49) | Polystyrene (1.60) |
| Polytetrafluoroethylene (1.36) | Polycarbonate (1.60) |
| Polyethylene (1.50) | Polyvinyl chloride (1.54) |

Optical Characterization and Rational Design of Structural Colored Patterns and Images

A detailed understanding of the optical properties of μ-TIR coatings under various illumination and usage conditions for 1) arrays of uniform structures, and 2) patterned arrays of multiple different microstructures to create images and custom color effects can be developed. The knowledge can be used to iterate the microstructure design to tune the optical properties of the surfaces that would be necessary for customization.

Approach to Standardized Optical Characterization of Diverse μ-TIR Surfaces

Given the diversity of μ-TIR surfaces that can be explored, a standard method for optical characterization is key to being able to compare the properties across samples and to compare to competitors' coatings. In order to objectively quantify the difference in optical properties of our μ-TIR coatings with various competing iridescent coatings, colorimetric characterization standards and methods currently used by industry can be implemented. These methods are based on measuring how different wavelengths of light are absorbed, reflected or transmitted through material but are based on specific protocols and measurement configurations agreed on by manufacturers, suppliers and sellers. Spectrophotometry can be used to quantify in CIELAB color space the iridescent color maps generated by coatings for a broad range of illumination angles and viewing angles. A glossmeter can be used to measure gloss index according to ASTM D523 for coatings produced with different polymers and processing methods. The degree of glossiness is quantified by measuring the intensity of reflected specular light at specified incident angles and has important implications for how a surface appears under diffuse versus direct lighting. Additionally, standard illumination conditions (daylight, incandescent, and fluorescent) can be adopted using a light booth when evaluating the visual color appearance and color differences between coatings. A refractometer (Rudolph Research Analytical) can be used to measure the refractive index of all starting materials.

An existing model to predict the iridescence and structural color from spherical interfaces for which collimated light undergoes TIR can be used to compare these measured values for benchmarking. From this earlier work are known trends, like the angular separation of the colors increases with a decrease in radius of curvature, higher refractive index contrast is needed to generate vibrant colors as the radius of curvature increases, and as refractive index contrast increases reflectivity overall to generate more pearlescent colors with lower saturation. For structures with non-spherical interfaces or for situations of non-collimated illumination, data or a model to predict the trends in structural color are not available. Such a model for optical interference can be computationally time consuming and expensive given the large microscale size of these structures and the fact that simplifications due to spherical symmetry cannot be made. Collection of these standardized characterization measurements for a range of geometries as proposed can allow building of a dataset and extraction of empirical trends to guide rational design of new structure color patterns.

Approach to Image Formation and Combinatorial Coloration

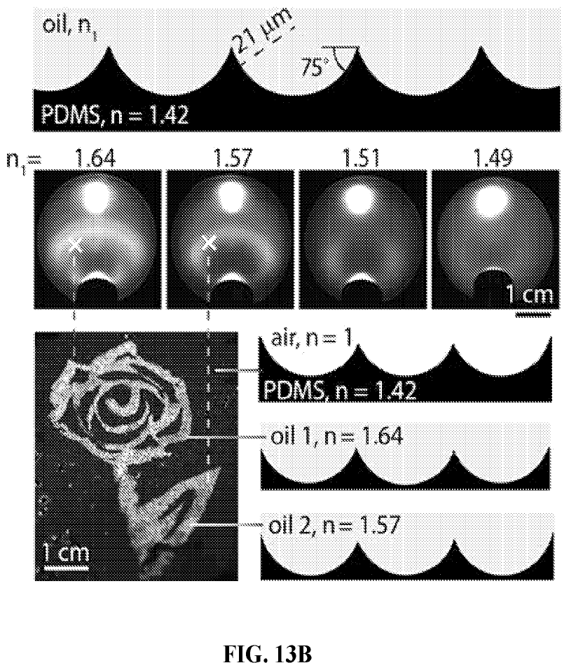

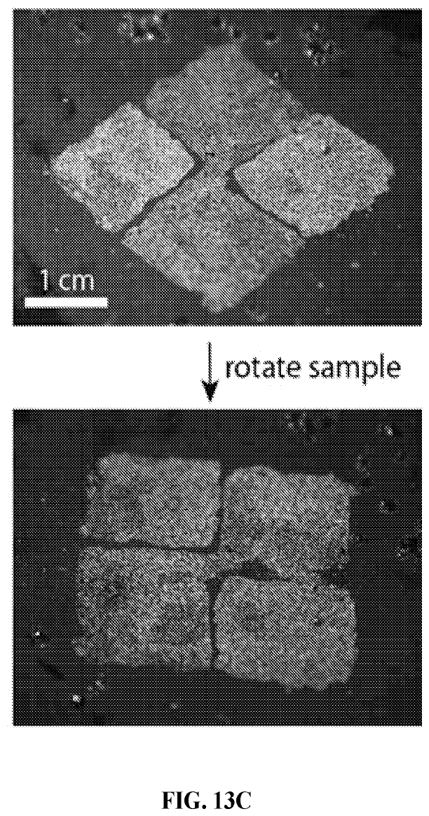

Based on an understanding of how varying microstructure size, shape and refractive index contrast affects the angular position, hue, saturation, and spatial organization of reflected color from our μt-TIR coatings, that data can be applied to design customizable surfaces that display dynamic colored images, text, or logos that shift with viewing or illumination conditions. In concept, this is similar to existing security holograms, but μ-TIR coatings have much broader optical variability such that significantly more distinct information can be encoded into a similar surface area, making the coatings more difficult to reverse engineer but easier to identify by the user. By patterning different combinations of microstructures across a surface or varying refractive index contrast, unique optical signatures and effects can be spatially programmed across a surface. a simple example of this in fluid droplets (FIG. 13A) and at fluid-solid interfaces (FIGS. 13B, 13C) has been demonstrated. Fabrication methods can be explored to design and fabricate such patterns into solids. For example, two different kinds of microstructures with partially overlapping color maps at specific polar viewing coordinates at the same incident light angle can both reflect the same or different colors depending on viewing conditions. Asymmetric microstructures (e.g., a hemicylinder) each reflecting color along orthogonal axes can be combined on a surface to effectively reveal or hide several images at certain viewing and illumination angles. Unlike diffraction gratings currently used in holographic coatings where the dimensional control over the appearance of iridescent coatings is controlled solely by the spacing and orientation of periodic nano-gratings, individual microstructure shape can be adjusted in multiple dimensions including size, curvature, faceting, and orientation to control the reflectivity of μ-TIR coatings. Such optical features may be effective for anti-counterfeiting coatings used for currency, credit cards, prescription drugs, or high-end goods.

Commercial Potential

Color is an incredibly important part of how we communicate with each other and interact with the objects around us. While many living organisms have evolved to exploit structural interference colors for such a purpose by biologically templating diverse nanoscale structures, we have relatively few methods for top-down nanofabrication to control optical interference. However, structural color, and optical interference coatings more broadly, are useful for technological, safety/security, and military applications with broad societal impact. Exploiting μ-TIR will open up significant opportunities for controlling interference in ways not before possible. By controlling variations in microstructure geometry (both for spherical and polygonal structures, angles, number of sides, lengths of sides, orientation) we will have far more control over the reflective optical properties of surfaces than is currently possible with thin film or diffraction due to limitations in nano-manufacturing. μ-TIR technology will enable fabrication of structural color in a greater diversity of materials without the need for metal film or oxide deposition, negating the use of high vacuum deposition conditions and reducing processing cost and energy usage. Beyond aesthetic applications of color in self-expression, such as for cosmetics, automotive paints, and apparel, structural color and tailored spectral reflectance of these coatings will have societal impact in applications including color-shifting holograms on security labels and anti-counterfeiting measures, camouflaging coatings, retroreflective signs and road markings, and laser-guided navigation. For example, new automotive paints that reflect IR radiation of lasers used for LIDAR while still allowing for customer choice amongst a broad range of colors (e.g. other than reflective white) will be critical for self-driving car technology. Structural colors, such as our μ-TIR coatings, may be a solution as the reflectivity can be tuned for specific wavelengths more easily than dyes or pigments, but there are currently no economical structural color automotive coatings. Security coatings are incredibly important not only for high value consumer goods, but importantly, to prevent counterfeit and potentially unsafe pharmaceutical drugs from entering the market. According to the World Health Organization, in 2017, 10% of medicines in developing countries were counterfeit, and sales of counterfeit drugs in 2010 topped US$75 billion worldwide. The market is growing rapidly. μ-TIR may provide a new route to the generation of optically variable coatings with distinct, customizable optical features that are difficult to reverse engineer and may provide an additional level of security to ensure patient safety.

The compositions and methods of the appended claims are not limited in scope by the specific compositions and methods described herein, which are intended as illustrations of a few aspects of the claims. Any compounds, compositions, and methods that are functionally equivalent are intended to fall within the scope of the claims. Various modifications of the compounds, compositions, and methods in addition to those shown and described herein are intended to fall within the scope of the appended claims. Further, while only certain representative compounds, components, compositions, and method steps disclosed herein are specifically described, other combinations of the compounds, components, compositions, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A method of producing a substrate that exhibits an interference pattern upon reflection of incident electromagnetic radiation, the method comprising
providing an interface master having the geometrical form of a plurality of total internal reflection (TIR) microstructure templates formed therein;
generating an microreplicated surface on a first material having a first refractive index from the interface master, wherein the microreplicated surface corresponds to and is a negative of the master; and
disposing a second material having a second refractive index on the microreplicated surface to produce the substrate that exhibits the interference pattern upon incident electromagnetic radiation;
wherein the substrate comprises a plurality of TIR microstructures, each of which comprises the first material, the second material abutting the first material, and an interface between the first material and the second material, and
wherein the interface is configured such that at least a portion of electromagnetic radiation incident a surface of the substrate at at least one illumination angle undergoes multiple total internal reflections between the first material and the second material.

2. The method of claim 1, wherein the interface comprises an arcuate interface.

3. The method of claim 2, wherein the arcuate interface is concave relative to the incident electromagnetic radiation.

4. The method of claim 1, wherein the interface comprises a plurality of sides.

5. The method of claim 4, wherein the interface comprises a truncated arcuate interface.

6. The method of any of claims 1-5, wherein electromagnetic radiation reflected by the plurality of TIR microstructures exhibits variable intensity based on the illumination angle.

7. The method of any of claims 1-6, wherein electromagnetic radiation reflected by the plurality of TIR microstructures exhibits variable intensity based on an angle of observation relative to the surface.

8. The method of any of claims 1-7, wherein electromagnetic radiation reflected by the plurality of TIR microstructures exhibits structural color.

9. The method of any of claims 1-8, wherein the first material comprises a polymer.

10. The method of claim 9, wherein the polymer comprises a thermoplastic, such as a polyester, a polyolefin, acrylic, acrylonitrile butadiene styrene (ABS), a polyamide, or any combination thereof.

11. The method of any of claims 1-10, wherein generating the microreplicated surface on the first material comprises a cast and cure process.

12. The method of any of claims 1-10, wherein generating the microreplicated surface on the first material comprises an injection molding process.

13. The method of any of claims 1-10, wherein generating the microreplicated surface on the first material comprises an embossing process.

14. The method of claim 13, wherein the embossing process comprises plate-to-plate embossing, roll-to-plate embossing, or roll-to-roll embossing of the first material.

15. The method of any of claims 1-14, wherein disposing the second material on the microreplicated surface comprises knife coating, dip coating, spray coating, printing, sputtering, evaporating, or spin coating the second material on the microreplicated surface.

16. The method of any of claims 1-14, wherein disposing the second material on the microreplicated surface comprises immersing the substrate in the second material.

17. The method of any of claims 1-14, wherein disposing the second material on the microreplicated surface comprises growing or precipitating the second material on the microreplicated surface.

18. The method of any of claims 1-17, wherein the second material comprises a curable resin.

19. The method of claim 18, wherein the second material comprises a UV curable resin, and the method further comprises irradiating the second material to cure the second material.

20. The method of claim 18, wherein the second material comprises a thermosetting resin, and the method further comprises heating the second material to cure the thermosetting resin.

21. The method of any of claims 1-17, wherein the second material comprises an inorganic material, such as MgF₂, SiO₂, TiO₂, or Al₂O₃.

22. The method of any of claims 1-21, wherein the difference between the first refractive index and the second refractive index is at least 0.01, such as from 0.05 to 1.5.

23. The method of any of claims 1-22, wherein the method further comprises forming the interface master having the geometrical form a plurality of TIR microstructure templates formed therein by a process selected from laser etching, laser deposition, photolithography, chemical etching, nickel electroforming, 3D printing, or combinations thereof.

24. The method of any of claims 1-22, wherein the method further comprises forming the interface master having the geometrical form a plurality of TIR microstructure templates formed therein by a process that comprises
ordering an array of sperical particles on a surface; and
heating the spherical particles to a temperature above a glass transition temperature, thereby deforming the particles to form an array of TIR microstructure templates.

25. The method of any of claims 1-22, wherein the method further comprises forming the interface master having the geometrical form a plurality of TIR microstructure templates formed therein by a process that comprises
ordering a population of particles at an interface;
fixing the population of particles within a base material, thereby forming an interface master comprising an array of TIR microstructure templates.

26. The method of claim 25, wherein fixing the population of particles within a base material comprises curing the particles in curable base material.

27. The method of claim 25, wherein fixing the population of particles within a base material comprises impressing the particles into a deformable base material.

28. The method of any of claims 1-27, wherein the plurality of TIR microstructures are disposed in a regular 2-dimensional array.

29. The method of any of claims 1-28, wherein the plurality of TIR microstructures are disposed in a regular 3-dimensional array.

30. The method of any of claims 1-29, wherein the method further comprises micronizing the substrate to form particulates or flakes that exhibit an interference pattern upon reflection of incident electromagnetic radiation.

31. The method of claim 30, wherein the particulates or flakes have a largest average cross-sectional dimension of less than about 500 microns.

32. The method of any of claims 30-31, wherein the the particulates or flakes have an aspect ratio of from 2:1 to 100000:1.

33. The method of any of claims 1-32, further comprising at least partially encapsulating the substrate in an optically transparent sealant.

34. The method of any of claims 1-33, further comprising applying an adhesive to the substrate.

35. The method of any of claims 1-34, wherein the method further comprises repeating the method of any of claims 1-34 to generate a second plurality of TIR microstructures on or within the substrate.

36. A method of producing a substrate that exhibits an interference pattern upon reflection of incident electromagnetic radiation, the method comprising
providing an interface master having the geometrical form of a plurality of total internal reflection (TIR) microstructure templates formed therein;
embossing a bilayer material using the interface master to produce the substrate that exhibits an interference pattern upon reflection of incident electromagnetic radiation;
wherein the bilayer material comprises a first layer formed from a first material having a first refractive index and a second layer abutting the first layer and formed from a second material having a second refractive index;
wherein the substrate comprises a plurality of TIR microstructures, each of which comprises the first material, the second material abutting the first material, and an interface between the first material and the second material;
wherein the interface corresponds to and is a negative of the interface master; and
wherein the interface is configured such that at least a portion of electromagnetic radiation incident a surface of the substrate at at least one illumination angle undergoes multiple total internal reflections between the first material and the second material.

37. The method of claim 36, wherein the interface comprises an arcuate interface.

38. The method of claim 37, wherein the arcuate interface is concave relative to the incident electromagnetic radiation.

39. The method of claim 36, wherein the interface comprises a plurality of sides.

40. The method of claim 39, wherein the interface comprises a truncated arcuate interface.

41. The method of any of claims 36-40, wherein electromagnetic radiation reflected by the plurality of TIR microstructures exhibits variable intensity based on the illumination angle.

42. The method of any of claims 36-41, wherein electromagnetic radiation reflected by the plurality of TIR microstructures exhibits variable intensity based on an angle of observation relative to the surface.

43. The method of any of claims 36-42, wherein electromagnetic radiation reflected by the plurality of TIR microstructures exhibits structural color.

44. The method of any of claims 36-43, wherein the first material comprises a first polymer and wherein the second material comprises a second polymer.

45. The method of claim 44, wherein the first polymer and the second polymer each comprise a thermoplastic, such as a polyester, a polyolefin, acrylic, acrylonitrile butadiene styrene (ABS), a polyamide, or any combination thereof.

46. The method of any of claims 36-45, wherein embossing the bilayer material comprises plate-to-plate, roll-to-plate, or roll-to-roll embossing of the first material.

47. The method of any of claims 36-46, wherein the difference between the first refractive index and the second refractive index is at least 0.01, such as from 0.05 to 1.5.

48. The method of any of claims 36-47, wherein the method further comprises forming the interface master having the geometrical form a plurality of TIR microstructure templates formed therein by a process selected from laser etching, laser deposition, photolithography, chemical etching, nickel electroforming, 3D printing, or combinations thereof.

49. The method of any of claims 36-47, wherein the method further comprises forming the interface master having the geometrical form a plurality of TIR microstructure templates formed therein by a process that comprises
ordering an array of spherical particles on a surface; and
heating the spherical particles to a temperature above a glass transition temperature, thereby deforming the particles to form an array of TIR microstructure templates.

50. The method of any of claims 36-47, wherein the method further comprises forming the interface master having the geometrical form a plurality of TIR microstructure templates formed therein by a process that comprises
ordering a population of particles at an interface;
fixing the population of particles within a base material, thereby forming an interface master comprising an array of TIR microstructure templates.

51. The method of claim 50, wherein fixing the population of particles within a base material comprises curing the particles in curable base material.

52. The method of claim 50, wherein fixing the population of particles within a base material comprises impressing the particles into a deformable base material.

53. The method of any of claims 36-52, wherein the plurality of TIR microstructures are disposed in a regular 2-dimensional array.

54. The method of any of claims 36-52, wherein the plurality of TIR microstructures are disposed in a regular 3-dimensional array.

55. The method of any of claims 36-54, wherein the method further comprises micronizing the substrate to form particulates or flakes that exhibit structural coloration.

56. The method of claim 55, wherein the particulates or flakes have a largest average cross-sectional dimension of less than about 500 microns.

57. The method of any of claims 55-56, wherein the the particulates or flakes have an aspect ratio of from 5:1 to 100000:1.

58. The method of any of claims 36-57, further comprising at least partially encapsulating the substrate in an optically transparent sealant.

59. The method of any of claims 36-58, further comprising applying an adhesive to the substrate.

60. The method of any of claims 36-59, wherein the method further comprises repeating the method of any of claims 36-59 to generate a second plurality of TIR microstructures on or within the substrate.

61. A method of producing a substrate that exhibits an interference pattern upon reflection of incident electromagnetic radiation, the method comprising
providing a pair of interface masters, each having the geometrical form of a plurality of total internal reflection (TIR) microstructure templates formed therein;
embossing a multilayer material between the pair of interface masters to produce the substrate that exhibits an interference pattern upon reflection of incident electromagnetic radiation;
wherein the multilayer material comprises a core layer formed from a first material having a first refractive index, a top layer abutting the core layer and formed from a second material having a second refractive index, and a bottom layer abutting the core layer and formed from a third material having a third refractive index;
wherein the substrate comprises a first array of TIR microstructures, each of which comprises the first material, the second material abutting the first material, and a first interface between the first material and the second material; and a second array of TIR microstructures, each of which comprises the first material, the third material abutting the first material, and a second interface between the first material and the third material;
wherein the first interface and the second interface correspond to and are a negative of the pair of interface masters;
wherein the first interface is configured such that at least a portion of electromagnetic radiation incident a surface of the substrate at at least one illumination angle undergoes multiple total internal reflections between the first material and the second material; and
wherein the second interface is configured such that at least a portion of electromagnetic radiation incident a surface of the substrate at at least one illumination angle undergoes multiple total internal reflections between the second material and the third material.

62. The method of claim 61, wherein the interface comprises an arcuate interface.

63. The method of claim 62, wherein the arcuate interface is concave relative to the incident electromagnetic radiation.

64. The method of claim 61, wherein the interface comprises a plurality of sides.

65. The method of claim 64, wherein the interface comprises a truncated arcuate interface.

66. The method of any of claims 61-65, wherein electromagnetic radiation reflected by the plurality of TIR microstructures exhibits variable intensity based on the illumination angle.

67. The method of any of claims 61-66, wherein electromagnetic radiation reflected by the plurality of TIR microstructures exhibits variable intensity based on an angle of observation relative to the surface.

68. The method of any of claims 61-67, wherein electromagnetic radiation reflected by the plurality of TIR microstructures exhibits structural color.

69. The method of any of claims 61-68, wherein the second material and the third material comprise the same material.

70. The method of any of claims 61-69, wherein the first material, the second material, and the third material each comprise a thermoplastic, such as a polyester, a polyolefin, acrylic, acrylonitrile butadiene styrene (ABS), a polyamide, or any combination thereof.

71. The method of any of claims 61-70, wherein the multilayer material comprises a trilayer material.

72. The method of any of claims 61-70, wherein the multilayer material comprises a four-layer material.

73. The method of any of claims 61-72, wherein embossing a trilayer material comprises plate-to-plate, roll-to-plate, or roll-to-roll embossing of the first material.

74. The method of any of claims 61-73, wherein the difference between the first refractive index and the second refractive index is at least 0.01, such as from 0.05 to 1.5; and wherein the difference between the first refractive index and the third refractive index is at least 0.01, such as from 0.05 to 1.5.

75. The method of any of claims 61-74, wherein pair of interface masters have the same geometrical form of a plurality of total internal reflection (TIR) microstructure templates formed therein.

76. The method of any of claims 61-74, wherein pair of interface masters each have a different geometrical form of a plurality of total internal reflection (TIR) microstructure templates formed therein.

77. The method of any of claims 61-76, wherein the method further comprises forming the pair of interface masters, each having the geometrical form a plurality of TIR microstructure templates formed therein, by a process selected from laser etching, laser deposition, photolithography, chemical etching, nickel electroforming, 3D printing, or combinations thereof.

78. The method of any of claims 61-76, wherein the method further comprises forming the pair of interface masters, each having the geometrical form a plurality of TIR microstructure templates formed therein, by a process that comprises
ordering an array of sperical particles on a surface; and
heating the spherical particles to a temperature above a glass transition temperature, thereby deforming the particles to form an array of TIR microstructure templates.

79. The method of any of claims 61-78, wherein the method further comprises forming the pair of interface masters, each having the geometrical form a plurality of TIR microstructure templates formed therein, by a process that comprises
ordering a population of particles at an interface;
fixing the population of particles within a base material, thereby forming an interface master comprising an array of TIR microstructure templates.

80. The method of claim 79, wherein fixing the population of particles within a base material comprises curing the particles in curable base material.

81. The method of claim 79, wherein fixing the population of particles within a base material comprises impressing the particles into a deformable base material.

82. The method of any of claims 61-81, wherein the plurality of TIR microstructures are disposed in a regular 2-dimensional array.

83. The method of any of claims 61-82, wherein the plurality of TIR microstructures are disposed in a regular 3-dimensional array.

84. The method of any of claims 61-83, wherein the method further comprises micronizing the substrate to form particulates or flakes that exhibit structural coloration.

85. The method of claim 84, wherein the particulates or flakes have a largest average cross-sectional dimension of less than about 500 microns.

86. The method of any of claims 84-85, wherein the the particulates or flakes have an aspect ratio of from 5:1 to 100000:1.

87. The method of any of claims 61-86, further comprising at least partially encapsulating the substrate in an optically transparent sealant.

88. The method of any of claims 61-87, further comprising applying an adhesive to the substrate.

89. The method of any of claims 61-88, wherein the method further comprises repeating the method of any of claims 61-88 to generate a second plurality of TIR microstructures on or within the substrate.

90. A method of forming a substrate that exhibits an interference pattern upon reflection of incident electromagnetic radiation, the method comprising
providing an interface master having the geometrical form of an array of total internal reflection (TIR) microstructure templates formed therein;
generating an microreplicated surface on a first material having a first refractive index from the interface master, wherein the embossed surface corresponds to and is a negative of the master;
disposing a first coating material on a first region of the microreplicated surface to produce the first region of the substrate that exhibits an interference pattern upon reflection of incident electromagnetic radiation; and
disposing a second coating material on a second region of the microreplicated surface to produce the second region of the substrate that exhibits differential structural coloration;
wherein the first coating material and the second coating material differ in one or more optical properties;
wherein the substrate comprises an array of TIR microstructures, each of which comprises the first material, a coating material abutting the first material, and an interface between the first material and the coating material, and
wherein the interface is configured such that at least a portion of electromagnetic radiation incident a surface of the substrate at at least one illumination angle undergoes multiple total internal reflections between the first material and the coating material.

91. The method of claim 90, wherein the one or more optical properties are chosen from absorption, transmission, refractive index, or any combination thereof.

92. The method of any of claims 90-91, wherein first coating material exhibits substantially the same optical properties as the first material, such that regions coated with the first coating materials do not exhibit multiple total internal reflections with regions coated with the second coating materials exhibit multiple total internal reflections.

93. The method of any of claims 90-91, wherein the first coating material and the second coating material are patterned on the microreplicated surface.

94. The method of any of claims 90-93, further comprising deforming a region of the microreplicated surface prior to disposing the first coating material on the microreplicated surface, such that the region where the microreplicated surface was deformed does not exhibit multiple total internal reflections.

95. A method of producing a substrate that exhibits an interference pattern upon reflection of incident electromagnetic radiation, the method comprising
fixing a population of particles formed from a first material having a first refractive index within a base material having a second refractive index, thereby forming an array of TIR microstructures, each of which comprises the first material, the base material abutting the first material, and an interface between the first material and the base material,
wherein the interface is configured such that at least a portion of electromagnetic radiation incident a surface of the substrate at at least one illumination angle undergoes multiple total internal reflections between the first material and the coating material.

96. The method of claim 95, wherein the population of particles are monodisperse in size.

97. The method of any of claims 95-96, wherein the population of particles have an average particle size of from about 5 microns to about 250 microns, such as from about 5 microns to about 150 microns.

98. The method of any of claims 95-97, wherein the population of particles exhibits an average degree of embeddedness within the base material of from 5% to 95%, as measured using optical profilometry.

99. The method of any of claims 95-98, wherein the particles exhibit a monodisperse degree of embeddedness, as measured using optical profilometry.

100. The method of any of claims 95-99, wherein fixing the population of particles within a base material comprises curing the particles in curable base material.

101. The method of any of claims 95-99, wherein fixing the population of particles within a base material comprises impressing the particles into a deformable base material.

102. A coating composition comprising particulates or flakes formed from a substrate material that exhibits an interference pattern upon reflection of incident electromagnetic radiation,
wherein the particulates or flakes have a largest average cross-sectional dimension of less than about 500 microns and an aspect ratio of from 2:1 to 100000:1;
wherein the substrate material comprises an array of TIR microstructures, each of which comprises a first material, the second material abutting the first material, and an interface between the first material and the second material;
wherein the interface is configured such that at least a portion of electromagnetic radiation incident a surface of the substrate at at least one illumination angle undergoes multiple total internal reflections between the first material and the second material.
